(19) United States
(12) Patent Application Publication
(10) Pub. No.: US 2019/0087474 A1
(43) Pub. Date: Mar. 21, 2019

(54) AUTOMATIC INGESTION OF DATA

(71) Applicant: Dharma Platform, Inc., Washington, DC (US)

(72) Inventors: Stefan Anastas Nagey, Washington, DC (US); James Charles Bursa, Washington, DC (US); Samuel Vincent Scarpino, Washington, DC (US); Conor Matthew Hastings, Washington, DC (US); Agastya Mondal, Washington, DC (US); Michael Roytman, Washington, DC (US)

(21) Appl. No.: 16/129,544

(22) Filed: Sep. 12, 2018

Related U.S. Application Data
(60) Provisional application No. 62/560,474, filed on Sep. 19, 2017.
(60) Provisional application No. 62/623,352, filed on Jan. 29, 2018.

(51) Int. Cl. G06F 17/30

(52) U.S. Cl. CPC G06F 17/30569; G06F 17/30575

(57) ABSTRACT

Presented here is a system for automatic conversion of data between various data sets. In one embodiment, the system can obtain a data set, can analyze associations between the variables in the data set, and can convert the data set into a canonical data model. The canonical data model is a smaller representation of the original data set because insignificant variables and associations can be left out, and significant relationships can be represented procedurally and/or using mathematical functions. In one embodiment, part of the system can be a trained machine learning model which can convert the input data set into a canonical data model. The canonical data model can be a more efficient representation of the input data set. Consequently, various actions, such as an analysis of the data set, merging of two data sets, etc. can be performed more efficiently on the canonical data model.

### CROSS-REFERENCE TO RELATED APPLICATION

This application claims priority to the U.S. Provisional Patent Application Ser. No. 62/560,474 filed Sep. 19, 2017, and U.S. Provisional Patent Application Ser. No. 62/623,352 filed Jan. 29, 2018 which are incorporated herein by this reference in their entirety.

### TECHNICAL FIELD

The present application is related to databases, and more specifically to methods and systems that automatically convert data between disparate data sets.

### BACKGROUND

Communication between disparate data sets today involves a significant amount of manual labor in converting the data structure contained in one database into data structure contained in the second database. Further, software that does exist focuses on particular types of databases. For example, the software can convert between a flat database and a relational database, but cannot convert between a flat database and a hierarchical database.

### SUMMARY

Presented here is a system for automatic conversion of data between various data sets. An input data set can be in a legacy database format, and the output data set can be a modern database format. In one embodiment, the system can obtain a data set, can analyze associations between the variables in the data set, and can convert the data set into a canonical data model. The canonical data model is a smaller representation of the original data set because insignificant variables and associations can be left out, and significant relationships can be represented procedurally and/or using mathematical functions. In one embodiment, part of the system can be a trained machine learning model which can convert the input data set into a canonical data model. The canonical data model can be a more efficient representation of the input data set. Consequently, various actions, such as an analysis of the data set, merging of two data sets, etc. can be performed more efficiently on the canonical data model.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 shows a system to efficiently perform an action on a data set.

FIG. 2 shows a data set input into the system, according to one embodiment.

FIG. 3 shows a portion of a canonical data model generated based on variables in FIG. 2.

FIGS. 4A-4B show a canonical data model with association between variables in FIG. 2.

FIG. 5A shows a data set input into the system, according to one embodiment.

FIG. 5B shows a graph generated from the data set in FIG. 5A.

FIG. 5C shows a compressed version of the data set in FIG. 5A.

FIG. 6 is a flowchart of a method to efficiently perform an action on a data set having a time dependency.

FIG. 7 is a flowchart of a method to convert a data set into a canonical data model, according to one embodiment.

FIGS. 8A-8C show steps in performing the action of lossy compression.

FIGS. 9A-9C show steps in performing the action of cleaning the canonical data model of spurious data.

FIG. 10A shows data cleaning and analysis performed by a processor while converting a data set.

FIG. 10B shows a hierarchical graph generated based on FIG. 10A and the measured associations between nodes.

FIG. 11 shows merging of two graphs based on graph connectivity.

FIG. 12 shows an analysis performed on the data set.

FIG. 13 is a flowchart of a method to convert a data set into a canonical data model, and efficiently perform an action on the data set, according to one embodiment.

FIG. 14 is a flowchart of a method to convert a data set into a canonical data model, and efficiently perform an action on the data set, according to one embodiment.

FIG. 15 is a flowchart of a method to efficiently perform an action on a nonhierarchical data set by constructing a hierarchical data model, according to one embodiment.

FIGS. 16A-B show a data set and a corresponding hierarchical data model.

FIG. 17 shows a system to efficiently perform an action on a data set using a machine learning model.

FIG. 18 shows confidence scores associated with a hierarchical data model.

FIG. 19 is a flowchart of a method to efficiently perform an action on a nonhierarchical data set by constructing a hierarchical data model, according to another embodiment.

FIG. 20 is a diagrammatic representation of a machine in the example form of a computer system within which a set of instructions, for causing the machine to perform any one or more of the methodologies or modules discussed herein, may be executed.

### DETAILED DESCRIPTION

### Terminology

Brief definitions of terms, abbreviations, and phrases used throughout this application are given below.

Reference in this specification to a “flat database” means a simple database in which each database is represented as a single table in which all of the records are stored as single rows of data, which are separated by delimiters such as tabs or commas, or any other kind of special character representing a break between records.

Reference in this specification to a “hierarchical database” means a database in which the data is organized into a tree-like structure. The data is stored as records which are connected to one another through links.

Reference in this specification to a “risk database” means a database in which risks associated with the project, potential solution to the risks, and other pertinent information are stored in one central location.

Reference the specification to a “relational database” means a database organizing data into one or more tables (or “relations”) of columns and rows, with a unique key identifying each row.

Risk database can at the same time include a flat database, a hierarchical database, a relational database, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example, using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Automatic Ingestion of Data Using Variable Categorization

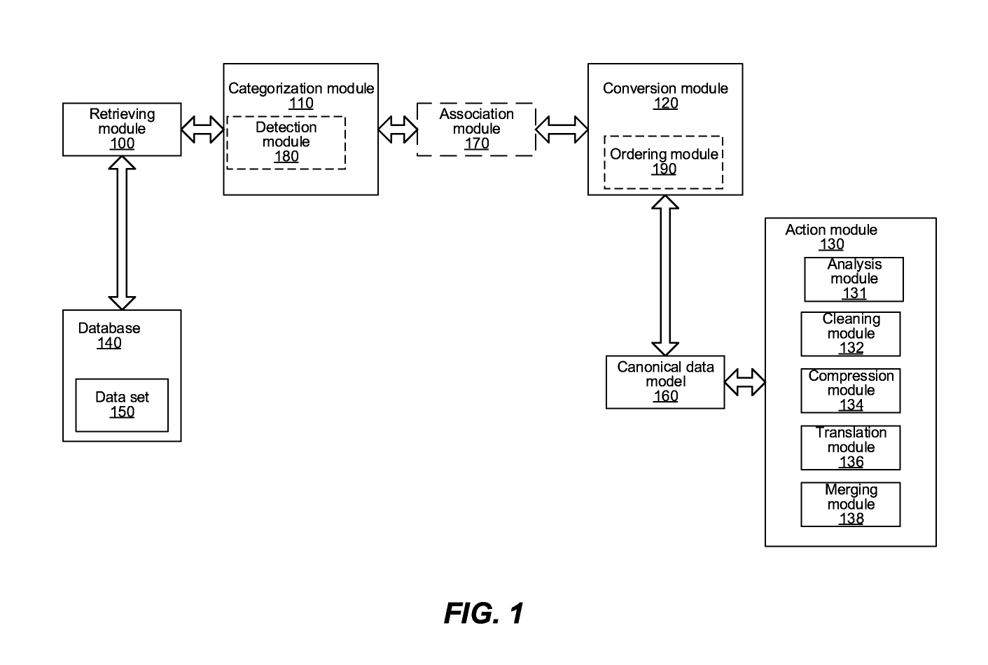

FIG. 1 shows a system to efficiently perform an action on a data set. The system includes a retrieving module 100, a categorization module 110, a conversion module 120, an action module 130, a database 140, a data set 150, a canonical data model 160, an optional association module 170, an optional detection module 180, and an optional ordering module 190. The detection module 180 can be part of the categorization module 110, or the detection module can execute after the retrieving module 100 and before the categorization module 110. The ordering module 190 can be part of the conversion module 120, or can execute after the conversion module 120 to produce the canonical data model 160.

The retrieving module 100 can obtain from a database 140 a data set 150, including multiple variables and multiple values associated with the multiple variables. The categorization module 110 can categorize multiple variables into a category including a continuous variable or a categorical variable. The continuous variable is a variable having a number of different values above a predetermined threshold. The categorical variable is a variable having a number of different values below the predetermined threshold. The predetermined threshold can be set to a number such as 100, or the predetermined threshold can be defined as a fraction of the total number of values the variable has. For example, the predetermined threshold can be one half of the total number of values. Consequently, when the variable has 20 values, and at least 11 of those values are different, the variable can be categorized as a continuous variable.

Categorical variables can include gender, marital status, profession, a time when a survey was performed, etc. continuous variables can include height, weight, length of time to do something, etc. The categories can be further refined. For example, the categorical variable can have subcategories such as yes/no responses, open responses, location-based data, time/date data, image, video, and/or audio. The continuous variable can have subcategories such as open responses, location-based data, time/date data.

The conversion module 120 can create the canonical data model 160 from the data set 150. The data set 150 can include multiple nodes. A node in the canonical data model 160 can represent the variable when the variable is continuous, and can represent a value of the variable, with the variable is categorical. The canonical data model 160 can be precomputed upon retrieval of the data set 150, and before any action needs to be performed on the canonical data model 160. The canonical data model 160 can be stored for later retrieval and for performance of an action. By pre-computing the canonical data model 160, the performance of the action at a later time is sped up because the pre-computing step is already performed, and can be performed once for multiple actions to be performed by the action module 130.

The action module 130 can perform an action on the canonical data model 160 more efficiently than performing the action on the data set 150 because the action module 130 can analyze all the values of the continuous variable as a single node, as opposed to analyzing each value separately. In other words, the efficiency comes from creating a continuous variable and compressing all the values into one node. The efficiency can be manifested in using less processor time to perform the action, consuming less memory in performing the action, consuming less bandwidth in performing the action, etc. The action module 130 can include various submodules for performing various additional actions explained further in this application. The submodules can include an analysis module 131, a cleaning module 132, a compression module 134, a translation module 136, a merging module 138, etc.

The association module 170 can determine an association between a pair of nodes in the canonical data model 160. The association can indicate a relationship between a value of the first node in the pair of nodes and a value of the second node in the pair of nodes.

The first and the second node can represent variables X and Y, which can be both continuous, both categorical, or one continuous and one categorical. The association between the nodes can be the correlation between the two nodes. The correlation coefficient is a measure of the degree of linear association between two continuous variables, i.e., when plotted together, how close to a straight line is the scatter of points. Correlation can measure the degree to which the two vary together. A positive correlation indicates that as the values of one variable increase the values of the other variable increase, whereas a negative correlation indicates that as the values of one variable increase the values of the other variable decrease. The standard method to measure correlation is Pearson's correlation coefficient. Other methods can be used such as Chi-squared test, or Cramer's V.

For example, correlation value can vary between −1 and 1. A value of 1 implies that a linear equation describes the relationship between X and Y perfectly, with all data points lying on a line for which Y increases as X increases. A value of −1 implies that all data points lie on a line for which Y decreases as X increases. A value of 0 implies that there is no linear correlation between the variables. In another example, correlation value can vary between 0 and 1, where one implies direct correlation, and 0 implies no correlation between two variables.

The association module 170 can create a connection in the canonical data model 160 between the pair of nodes when the association between the pair of variables exceeds an association threshold. The association between variables is measured in absolute terms. In other words, a negative association is treated as a positive association of the same magnitude. The association threshold can be 0.1, indicating that none of the associations in the −0.1 to 0.1 range are represented as connections in the canonical data model 160. For example, an association having a value of −0.2, would, as a result, be represented in the canonical data model 160. If one of the variables X or Y represented by the first or second node in the canonical data model 160 is a time variable, the time variable can have a different association threshold, which we can be higher or lower than the association threshold for the variables that are not time variables.

The detection module 180 can detect in the data set a time variable representing a time associated with a variable in the data set, as described in this application. The time variable can be associated with a single variable, or multiple variables.

The association module 170 can determine an association between a pair of nodes, where at least one variable is a time variable, in the canonical data model 160. The conversion module 120 can create a connection between the pair of nodes when the association between the pair of nodes is above an association threshold. From creating a connection, the ordering module 190 can determine a number of values that the time variable has, and order the values of the time variable in a chronological sequence. The association threshold can be less than the predetermined threshold due to the fact that a variable's value can change unexpectedly over time. For example, the association threshold can be 0.01. Once the association between the pair of nodes is above the association threshold, the ordering module 190 can check that the number of values that the time variable has is substantially equal to a number of values associated with the other node in the pair of nodes, and can order the values of the other node in the chronological sequence.

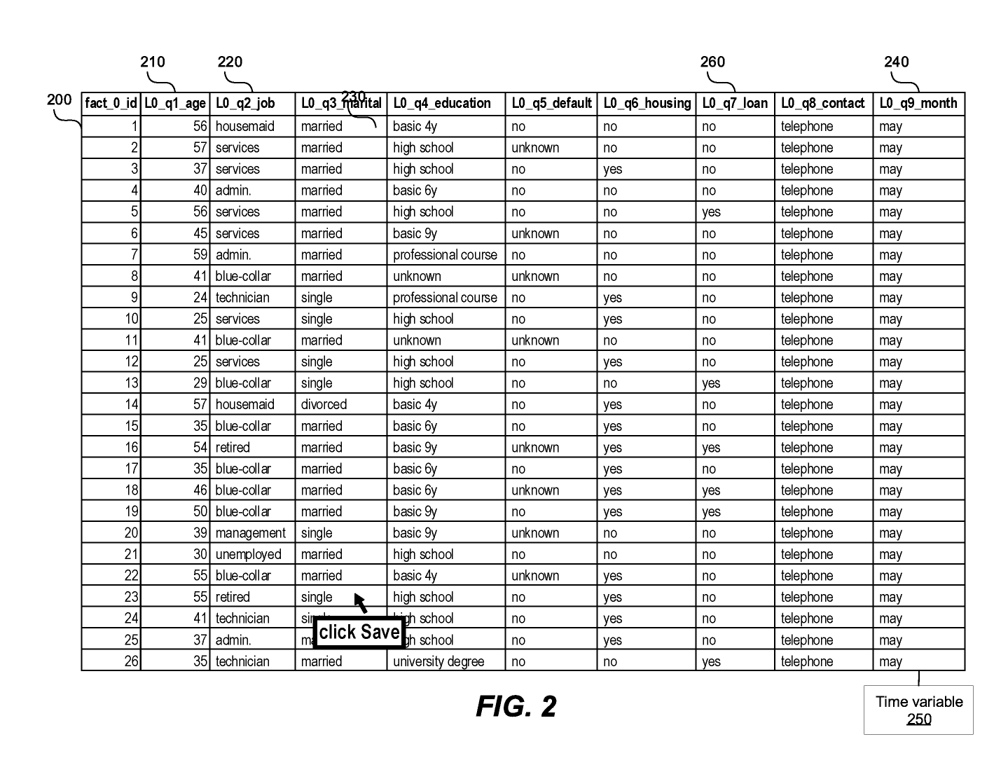

FIG. 2 shows a data set input into the system, according to one embodiment. The data set can be the data set 150 in FIG. 1. The data set in FIG. 2 is an example of a flat database. The data set includes multiple rows 200 (only one labeled for brevity), and multiple columns 210, 220, 230, 240, 260, 260 (only five labeled for brevity). The rows 200 can correspond to the answers collected from a single respondent. The columns 210, 220, 230, 240, 260 can represent various variables, while the values contained in the columns 210, 220, 230, 240, 260 can represent values associated with the variables 210, 220, 230, 240, 260. The values associated with the variables 210, 220, 230, 240, 260 can correspond to various answers collected from multiple respondents. For example, the column 210 provides the age of the respondents in the study. Column 260 is an example of a categorical variable with yes/no answers. Other columns 220, 230, 240 can provide respondents' profession, marital status, education, housing, loans, preferred means of contact, date when the answer was collected, etc.

Column 240 represents a time variable associated with the rest of the variables, i.e., columns 210, 220, 230 etc., in the study. Column 240 can represent the date when the data contained in the rest of the columns 210, 220, 230 was collected. The processor and/or the detection module 180 in FIG. 1 can detect the time variable 240 in several ways. That detection module 180 can run on the processor.

For example, the processor and/or the detection module 180 can obtain multiple labels associated with the multiple variables. In a more specific example, labels “L0_q1_age,” “L0_q2_job,” “L0_q3_marital,” and “L0_q9_month” are associated with the variables 210, 220, 230 and 240, respectively. The label “L0_q9_month” associated with the variable 240 contains a name of a unit of measuring time, namely “month.” Other names of units of measuring time can contain a year, a month, a name of the month, a day, a time of day, “AM”, “PM”, minutes, seconds, hours, etc. Consequently, the processor and/or the detection module 180 can detect the unit of measuring time in the label associated with the variable 240.

In another example, the processor and/or the detection module 180 can obtain the values associated with the variable 210, 220, 230, 240, 260, and inside the value detect the unit of measuring time such as a year, a month, a name of the month, a time of day, “AM”, “PM”, minutes, seconds, hours, etc. In a more specific example, in the table in FIG. 2, the processor and/or the detection module 180 can detect the value “may”, which is a name of a month, and as a result detect that variable 240 is a time variable.

In a third example, the table in FIG. 2 can have metadata 250 associated with one or more columns 210, 220, 230, 240, 260. The metadata 250 can indicate a property of the column 210, 220, 230, 240, 260, such as whether the column is a time variable.

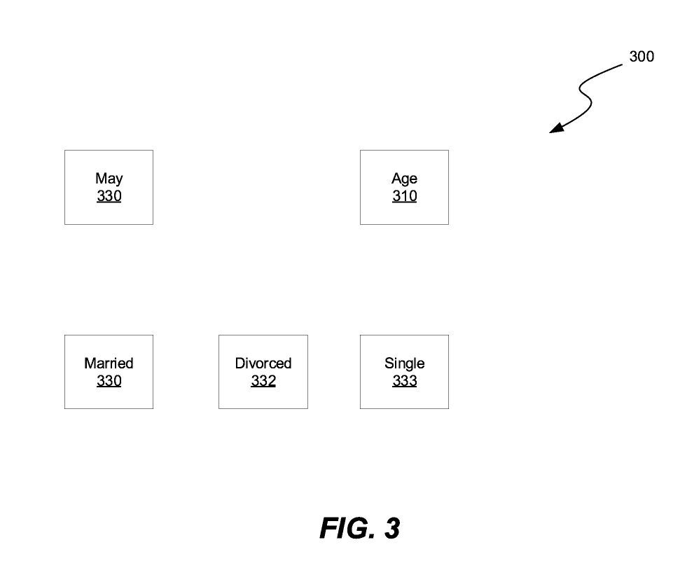

FIG. 3 shows a portion of a canonical data model generated based on variables 210, 230 and 240 in FIG. 2. The canonical data model 300 includes nodes 310, 330, 332, 334, 340.

Node 310 represents the age variable 210 in FIG. 2. The variable 210, representing age, is classified as a continuous variable because the total number of values of the variable 210 in FIG. 2 is 26, and the total number of different values of the variable 210 is 18. Assume that a predetermined threshold is one half of the total number of values. Consequently, since the total number of different values of the age variable 18 is greater than 13, the variable 210, representing age, is classified as a continuous variable, and consequently represented as a single node in the graph 300.

Nodes 330, 332, 334 represent variable 230 in FIG. 2. The variable 230, representing marital status, is classified as a categorical variable because the total number of values of the variable 230 in FIG. 2 is 26, and the total number of different values of the variable 230 is 3, namely single, married, divorced. Since 3 is less than one half of 26, the variable 230 representing age is classified as the categorical variable, and the different values of the variable 230 are represented as nodes 330, 332, 334 in the graph 300.

Node 340 represents variable 240 in FIG. 2. The variable 240, representing time, is classified as a categorical variable because the total number of values on the variable 240 in FIG. 2 is 26, and the total number of different values of the variable 240 is one, namely “May”. Consequently, as described in this application, the variable 240, representing time, is classified as categorical, and the only value of the variable 240 is represented as a node 340 in the graph 300.

Graph 300 is a compact representation of the variables 210, 230, 240 in FIG. 2. Consequently, the graph 300 has a smaller a memory footprint of the data set shown in FIG. 2. Therefore, representing the data set in FIG. 2 as the graph 300 is a compression technique. Further, performing various actions on the graph 300 is more efficient than performing the same actions on the data set shown in FIG. 2.

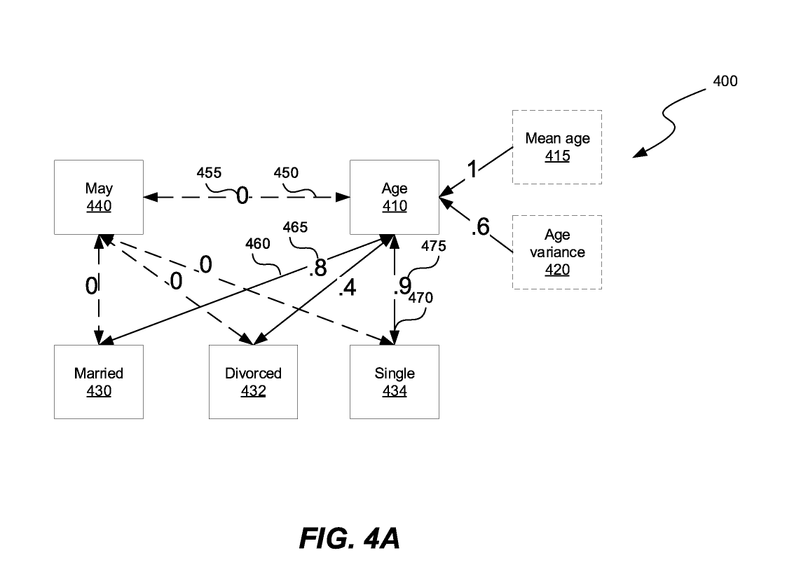

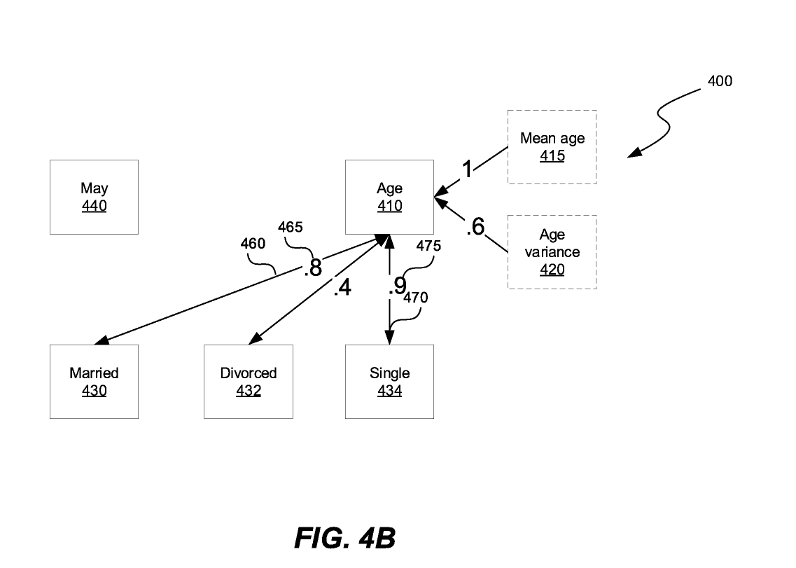

FIGS. 4A-4B show a canonical data model with association between variables 210, 230 and 240 in FIG. 2. The canonical data model 400 includes nodes 410, optional node 415, optional node 420, 430, 432, 434, 440. The nodes 410, 415, 420 430, 432, 434, 440 can be connected with each other using connections 450, 460, 470 (only 3 labeled for brevity). The connections 450, 460, 470 represent associations between nodes 410, 415, 420 430, 432, 434, 440. The connections 450, 460, 470 can have corresponding weights 455, 465, 475, respectively, to indicate the magnitude of association between two nodes.

Optional node 415 can be added to a node representing a continuous variable, such as node 410, to represent a mean of the continuous variable 410. Similarly, optional node 420 can be added to the node 410 representing the continuous variable, to represent a variance of the continuous variable 410. Because the nodes 415, 420 have directed depend on the node 410, the association between the node 410 and the nodes 415, 420 is one, as shown in FIGS. 4A-4B.

In FIG. 4B the association between nodes that are below a predetermined threshold have been deleted out of the canonical data model 400. The predetermined threshold can be a value of 0.2, for example.

Graph 400 is a compact representation of the variables 210, 230, 240 in FIG. 2. Consequently, the graph 400 has a smaller memory footprint of the data set shown in FIG. 2. Therefore, representing the data set in FIG. 2 is the graph 400, a compression technique. Further, performing various actions on the graph 400 is more efficient than performing the same actions on the data set shown in FIG. 2.

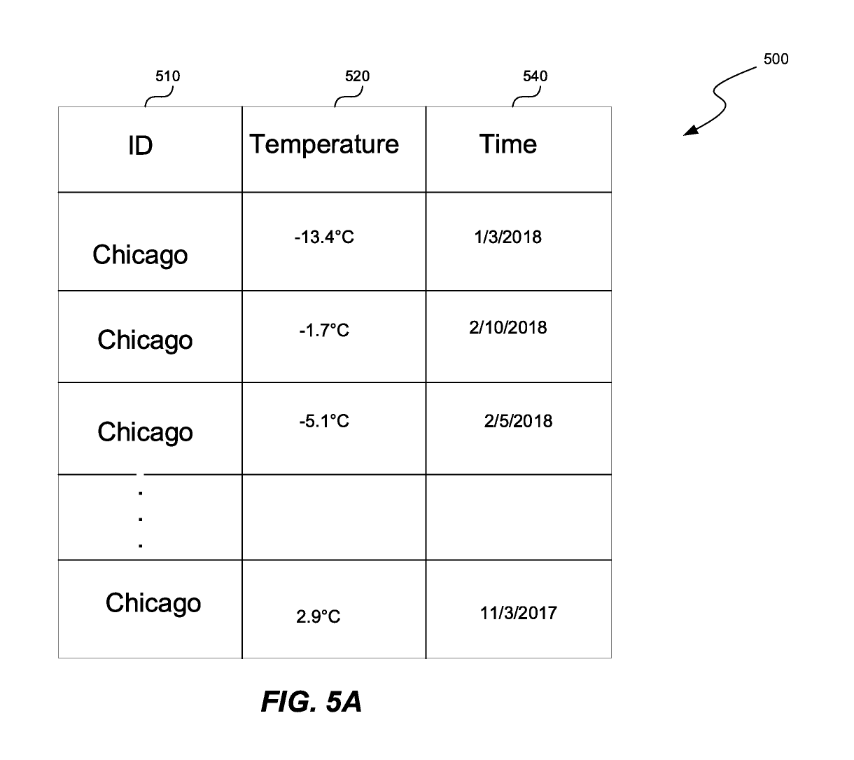

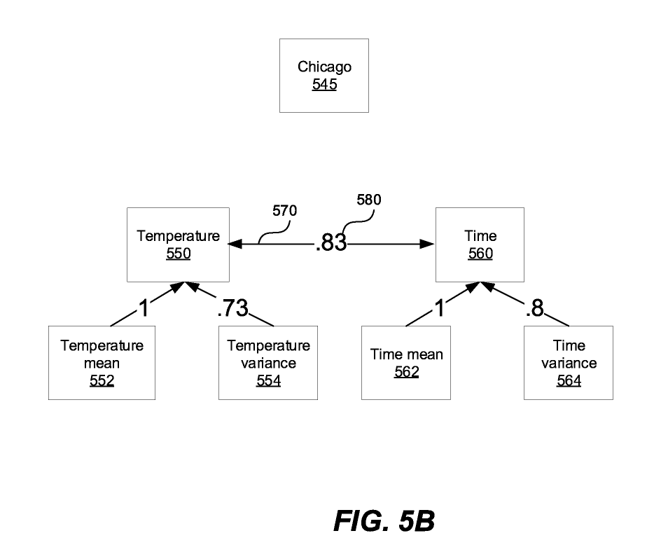

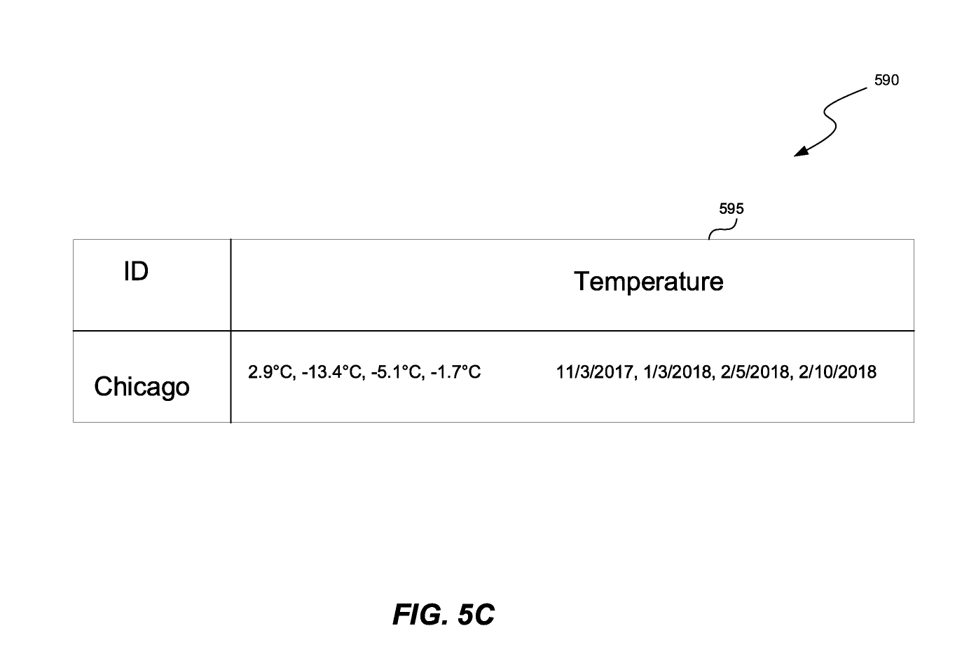

FIG. 5A shows a data set input into the system, according to one embodiment. The input data 500 set can be the data set 150 in FIG. 1. The data set 500 includes multiple columns 510, 520, 530. Column 500 specifies the city, column 520 specifies an average daily temperature, and column 530 specifies the day during which the temperature was measured.

FIG. 5B shows a graph generated from the data set 500 in FIG. 5A. The graph 540 contains nodes 545, 550, 560, and optional nodes 552, 554, 562, and 564, a connection 570, and an association 580. Node 550 represents time variable of the column 520 in FIG. 5B. The time variable 520 is classified as a continuous variable, because all the values of the time variable are different, as described in this application. Node 560 represents temperature variable of the column 530 in FIG. 5A. The temperature variable 530 is classified as a continuous variable, because all the values of the temperature variable are different, as described in this application.

A processor and/or the association module 170 in FIG. 1 can calculate the association 580 between the nodes 545, 550, 560. When the association 580 between the nodes 545, 550, 560 is above a predetermined threshold, the association 580 is represented as a connection 570 in the graph 540. Alternatively, the connection 570 can be always created between two nodes, such as nodes 550, 560, and can later be deleted if the association 580 between the two nodes 550, 560 is below the predetermined threshold. For example, the connections between nodes 545 and 550, and connection between the nodes 545 and 560 has been deleted because the associations have a value of 0, below the predetermined threshold.

A processor and/or the ordering module 190 in FIG. 1 can determine a number of time values associated with the time variable 550 and can order the time values in a chronological sequence. Further, when a number of time values is substantially equal to a number of values associated with the second node 560, and the association 580 between the pair of nodes 550, 560 is above an association threshold, the processor and/or the ordering module 190 can order the number of values associated with the second node 560 in the chronological sequence.

FIG. 5C shows a compressed version of the data set 500 in FIG. 5A. Once the values of the variables 550, 560 are ordered, the processor and/or the ordering module 190 can compress the two variables into a longitudinal record 595 representing a varying variable value over time. Further, since there is only one value for the node 545, the processor and/or the ordering module 190 can compress the data set 500 to obtain data set 590, representing at least a fourfold decrease in memory usage as compared to the data set 500. This type of compression, where no data is lost, is called lossless compression. In the case described in FIG. 5C, repeated values of the variable “Chicago” have been represented with a single value “Chicago.”

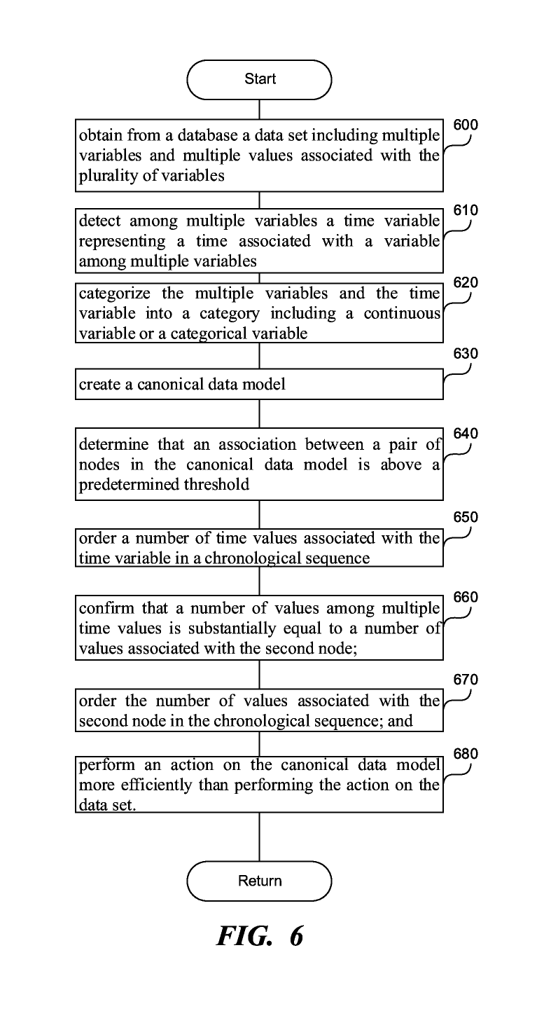

FIG. 6 is a flowchart of a method to efficiently perform an action on a data set having a time dependency. In step 600, a processor can obtain, from a database, a data set including multiple variables and multiple values associated with the multiple variables. In step 610 the processor can detect, among multiple variables, a time variable representing a time associated with a variable among multiple variables.

In step 620, the processor can categorize the multiple variables and the time variable into a category including a continuous variable or a categorical variable. The continuous variable can be a variable having a number of values above a predetermined threshold, and the categorical variable can be a variable having a number of values below a predetermined threshold, as described in this application. The continuous variable can also be a numeric variable having an infinite number of values between any two values, and the categorical variable can be a variable having a finite number of values. For example, categorical variables can include gender, material type, and payment method, while a continuous variable can be the length of a part or the date and time a payment is received.

In step 630, the processor can create a canonical data model including multiple nodes. The nodes can be based on the variable category. A node can represent a continuous variable as a first node in the canonical data model, and can represent a value of the categorical variable as a second node in the canonical data model. The step of categorizing the variables can be a pre-computation step, done only once, and storing the canonical data model in a database. When an operation is to be performed on the data set, the canonical data model is retrieved from the database, and the operation is performed on the canonical data model, because performing the operations of the canonical data model is faster, as described in this application.

In step 640, the processor can determine that an association between a pair of nodes in the canonical data model is above a predetermined threshold. The association can indicate a relationship between a value of the first node in the pair of nodes and a value of the second node in the pair of nodes, where the first node can represent the time variable.

In step 650, the processor can order all the time values associated with the time variable in a chronological sequence. In step 660, the processor can confirm that a number of values of the time variable is substantially equal to a number of values associated with the second node. In step 670, the processor can order the values associated with the second node in the chronological sequence.

In step 680 the processor can perform an action on the canonical data model more efficiently than performing the action on the data set by analyzing the number of values of the continuous variable as a single node. In other words, each value of the continuous variable is not analyzed separately. The efficiency comes from creating a continuous variable and compressing all the values into one node, for efficient analysis.

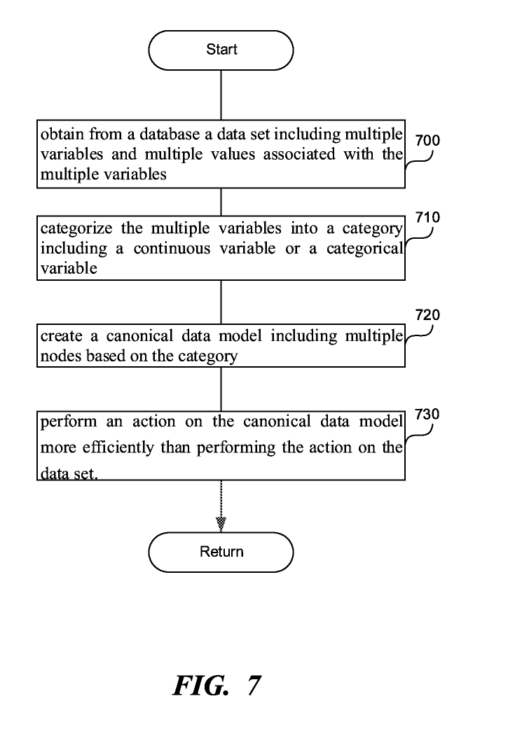

FIG. 7 is a flowchart of a method to convert a data set into a canonical data model, according to one embodiment. In step 700, a processor can obtain, from a database, a data set including multiple variables and multiple values associated with the multiple variables.

In step 710, the processor can categorize the multiple variables into a category including a continuous variable or a categorical variable. The continuous variable can be a variable having a number of values above a predetermined threshold, while the categorical variable can be a variable having a number of values below a predetermined threshold. The continuous variable can be a numeric variable having an infinite number of values between any two values, while the categorical variable can have a finite number of values. Other categories can exist, such as open response, location data, time-based data, yes/no data, image, audio, video, 3-dimensional model data, etc. these other categories can be subcategories of the continuous and/or the categorical variable.

In step 720, the processor can create a canonical data model including multiple nodes based on the category to which the variable that the node represents belongs. The processor can represent the all values of the continuous variable as a first i.e., single, node in the canonical data model, and can represent a value of the categorical variable as a second node in the canonical data model. In other words, the number of nodes representing a categorical variable is equal to the number of different values that the categorical variable has. The step of generating the canonical data model can be a pre-computation step, as described in this application, increasing the efficiency of operations on the data set.

In step 730, the processor can perform an action on the canonical data model more efficiently than performing the action on the data set by analyzing the number of values of the continuous variable as the first node. In other words, each value of the continuous variable is not analyzed separately, so that the efficiency comes from compressing all the values of a continuous variable into one node.

For example, performing the action can include efficiently converting between two data sets. The processor and/or the translation module 136 in FIG. 1 can perform the action. The processor can also execute the instructions of the translation module 136. The processor and/or the translation module 136 can obtain the canonical data model 160 in FIG. 1 representing the first data set 150 in FIG. 1, and a format of a second database. The format of the second database can include at least one of a flat database, a relational database, or a risk database. The processor and/or the translation module 136 can convert the canonical data model 160 into the format of the second database.

In another example, performing the action can include merging disparate data sets. The disparate data sets can have same labels for same variables, or can have different labels for same variables. For example, the first data sets can represent the location of the respondent with the label “city”, while the second data set can represent the location with “region.” The processor and/or the merging module 138 in FIG. 1 can perform the action. The processor can execute instructions of the merging module 138.

The processor and/or the merging module 138 can obtain a second canonical data model from a second data set. For example, the processor and/or the merging module 138 can generate the canonical data model, or can retrieve it from a database for the second canonical data model has been precomputed and stored.

The processor and/or the merging module 138 can determine the corresponding variables between the data set, such as data set 150 in FIG. 1, and the second data set based on the structure of the canonical data model and the second structure of the second canonical data model. In a more specific example, the processor and/or the merging module 138 can determine corresponding variables based on: similarity of values between a variable in the data set in a variable in the second data set, similarity of node connectivity between a node in the canonical data model and a node in the second canonical data model, and/or similarity of associations between a node in the canonical data model and a node in the second canonical data model, etc.

The processor and/or the merging module 138 can merge the corresponding variables in the data set and the second data set into a merged data set. Other examples of the actions performed by the action module are discussed below.

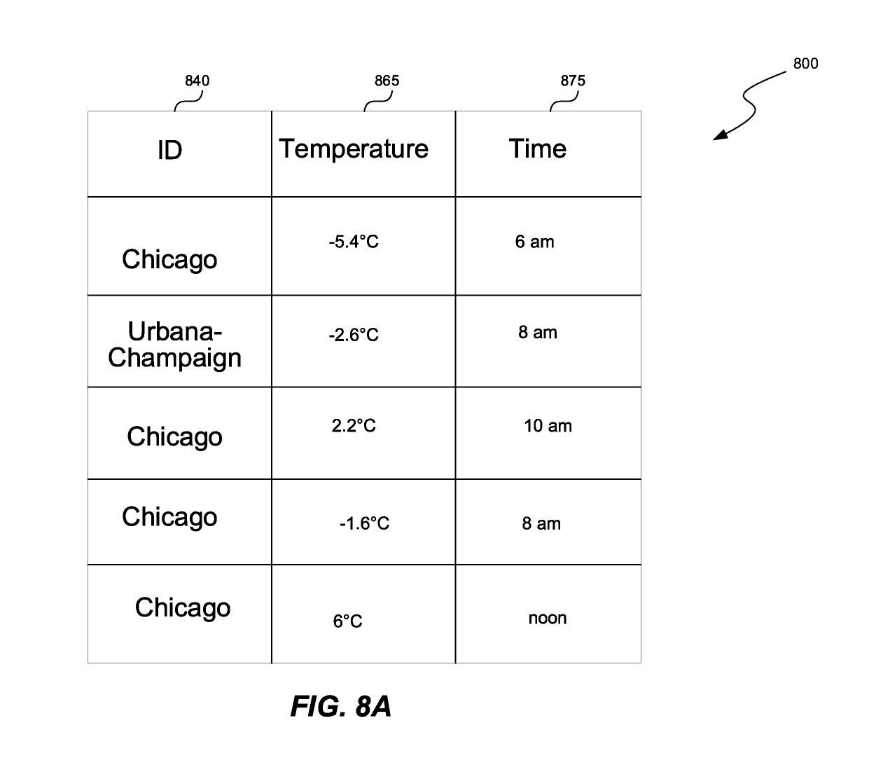

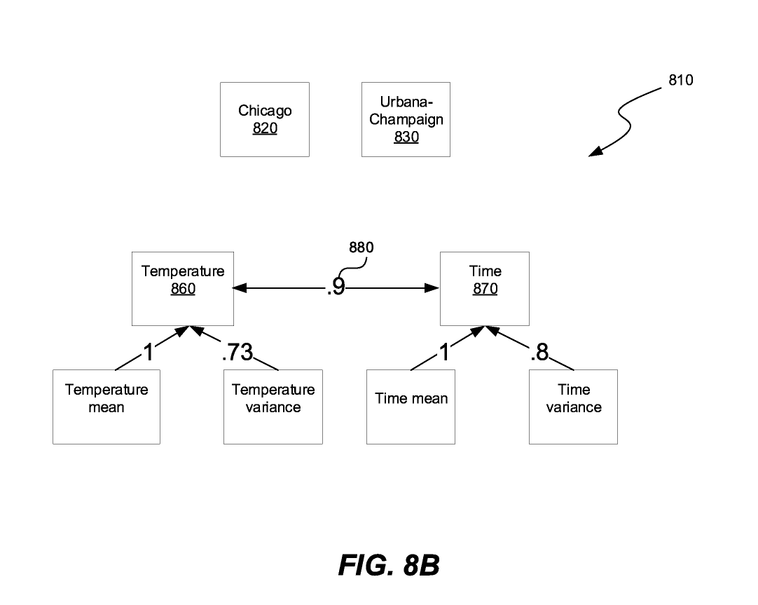

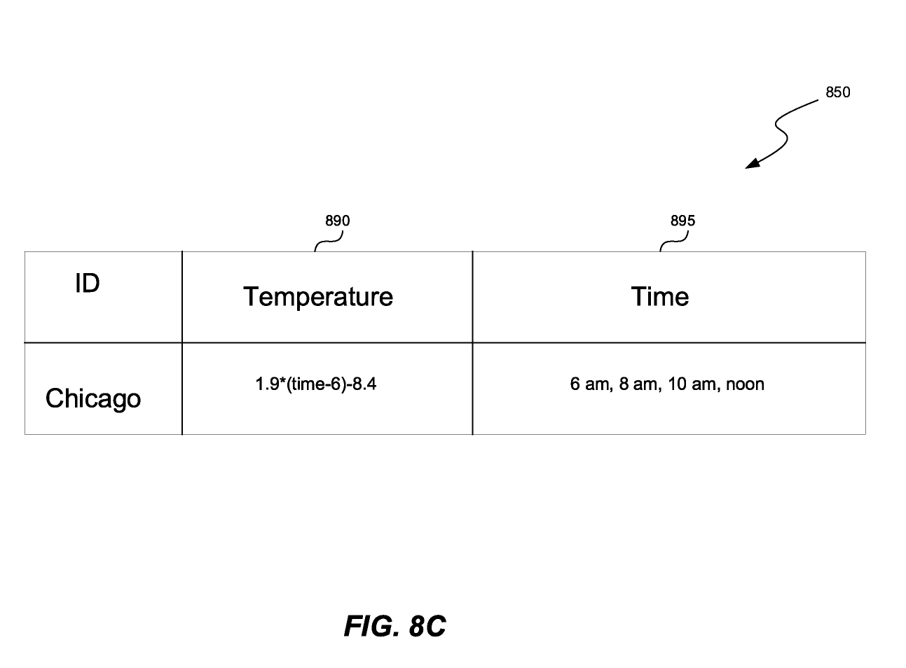

FIGS. 8A-8C show steps in performing the action of lossy compression. FIG. 8A shows a data set 800, representing a temperature recorded during the course of a single day in Chicago and Urbana-Champaign. FIG. 8B shows a canonical data model 810 generated from the data set 800 and FIG. 8A. One or more of the nodes in the canonical data model 810 can represent a time variable, or none of the nodes can represent the time variable. The nodes 820, 830, representing the variable 840 in FIG. 8A, do not have a high association with the rest of the nodes in the canonical data model 810.

A processor can detect that the nodes 820, 830 have an insignificant association with the rest of the of nodes, and can compress the value of the variable 840 associated with the nodes 820, 830 using lossy compression. For example, the processor can average the value of the nodes 820, 830. In this case, the processor can average the latitude and longitude of Chicago and latitude and longitude of Urbana-Champaign. Because Chicago is a more frequent entry in the data set 800, the average of the latitude and longitude, approximates the position of Chicago, and the lossy compression would yield a data set 850 shown in FIG. 8C. In another example, the lossy compression can delete an infrequently appearing value, such as Urbana-Champaign. In a third example, the lossy compression can perform the averaging of the values based on the area of the city, or some other kind of waiting metal method, which gives higher weight to a more dominant value of the variable 840.

A processor can also detect that two nodes 860, 870 in FIG. 8B have a high association with each other. When the association 880 in FIG. 8B is above a predetermined threshold, such as 0.8, the processor can compress the value of the variable 865 in FIG. 8A associated with the node 860, by representing the value of the variable 865 as a function of variable 875 associated with the node 870. FIG. 8C shows the compressed data set 850, in which the value of the temperature variable 890 is expressed as a function of the time variable 895. The function can be a piece of code, i.e., a procedural representation, and/or a mathematical function. As a result, the compressed data set 850 takes approximately 50% as much memory as the compressed data set 590 in FIG. 5C. Consequently, the compressed data set 850 takes approximately 12.5% memory as compared to the data set 800 and FIG. 8A.

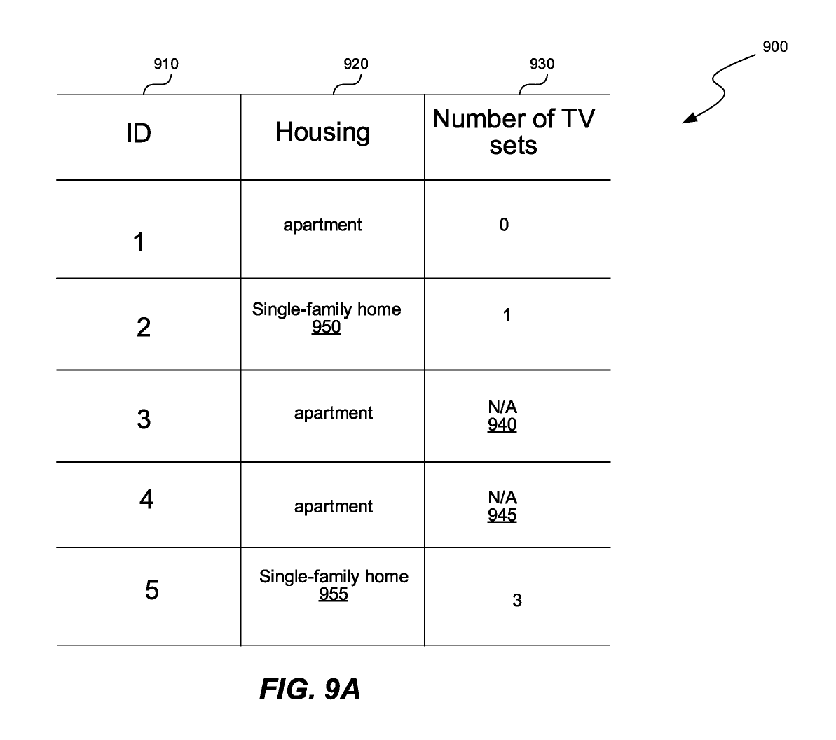

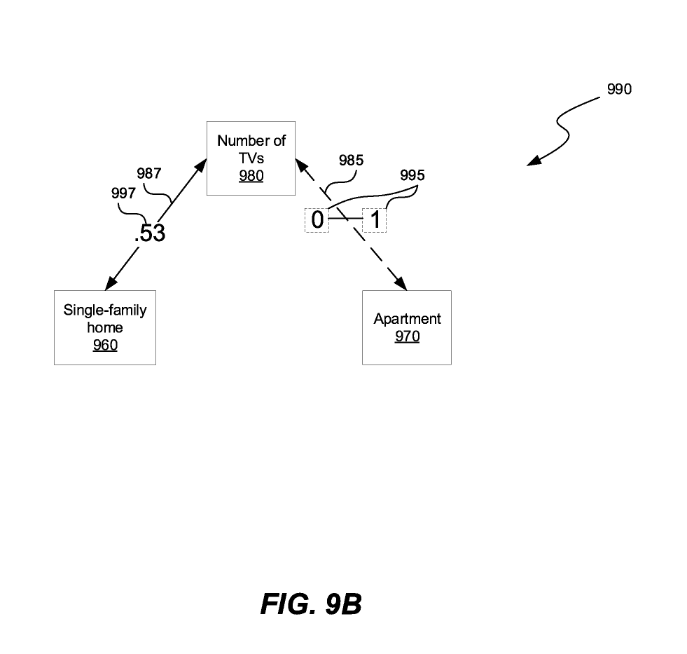

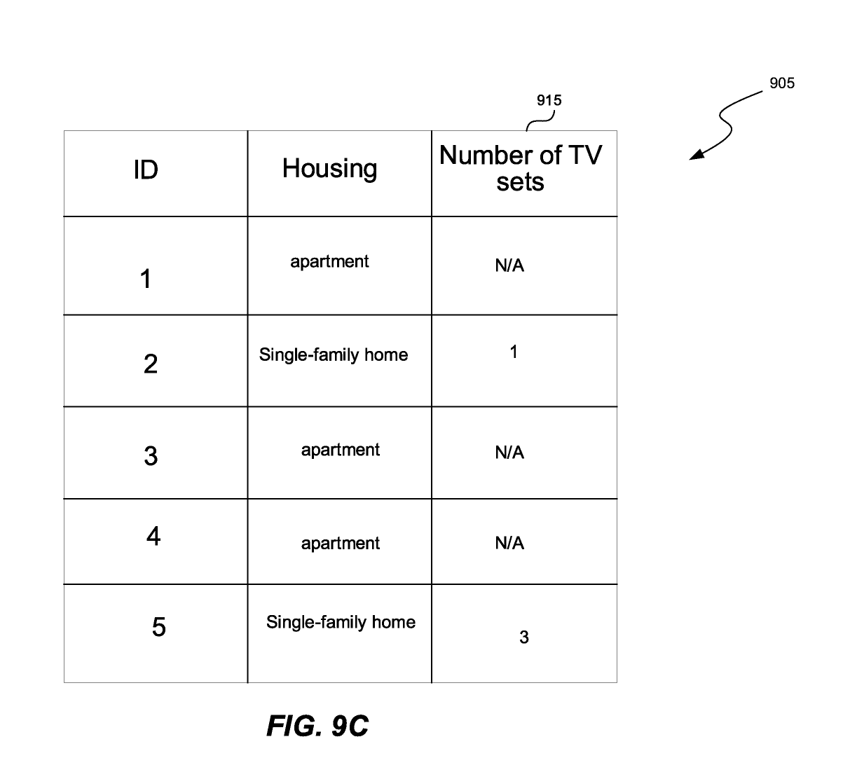

FIGS. 9A-9C show steps in performing the action of cleaning the canonical data model of spurious data. The data set 900 in FIG. 9A shows answers collected from correspondents listed in column 910, regarding the housing situation, column 920, and how many TVs they have, column 930. The column 930, representing how many TVs the respondents have, has several missing values 940, 945. The missing values 940, 945 can be due to the omission from the collector to enter the data, or can be due to the structure of the questionnaire presented. For example, the questionnaire can be structured to query about the number of televisions only if the response to the housing situation has a value of “single-family call,” as shown in entries 950, 955. Thus, the missing values 940, 945 are due to the fact that they were not supposed to be entered at all.

Graph 990 in FIG. 9B contains nodes 960, 970, 980, connections 985, 987 and associations 995, 997. Nodes 960, 970 represent values of the variable 920, namely, “single-family home”, and “apartment,” because variable 920 is a categorical variable. Node 980 represents the variable 930, because variable 930 is a continuous variable. The association 995 representing an association between nodes 970, 980 can have various values, depending on a method of quantitation is described below.

In computing the association 995, 997 between the nodes 960, 970, 980 in the graph 990 in FIG. 9B, the processor and/or cleaning module 132 in FIG. 1, can detect the missing values in column 930, when the value in column 920 is “apartment”. In one embodiment, the processor and/or the cleaning module 132 can determine whether there are more missing values or more “0” values, when the value in column 920 is “apartment”. In the data set 900 there are more missing values, and the processor and/or the cleaning module 132 can replace the “0” values with the missing values. In that case, the association 995 between the nodes 970, 980 is 0. If there are more “0” values then missing values, the missing values can be replaced with “0” values. Further, the processor and/or the cleaning module 132 can determine the mode value of the column 930, and replace the missing value with the mode value. If the missing values have been replaced with an actual value, such as the mode, an average, etc., the association module 170 in FIG. 1 can continue to calculate the association between the nodes 960, 970, 980.

In another embodiment, the processor and/or the cleaning module 132 can ignore the missing values, and calculate the association between values that are present in column 930 in FIG. 9A, when the value of column 920 is “apartment”. The calculated association 995 is high, in the present case 1, because the same value in column 920, namely “apartment” corresponds to the same value of the number of TVs in column 930, namely “0”. If such a high association is detected, the processor can check the structure of the questionnaire to see if the two variables are related due to the questionnaire design. Examination of the questionnaire structure can reveal the fact that the question about the number of TVs is only asked of respondents dwelling in a single-family home. Consequently, the connection 985 between nodes 970 and 980 can be deleted due to the error of the collector.

After cleaning the values in column 930, the clean data set 905 in FIG. 9C can be generated. The clean data sets 905 in column 915 can contain the corrections to the erroneously entered values “0” in the column 920, namely, “N/A” values.

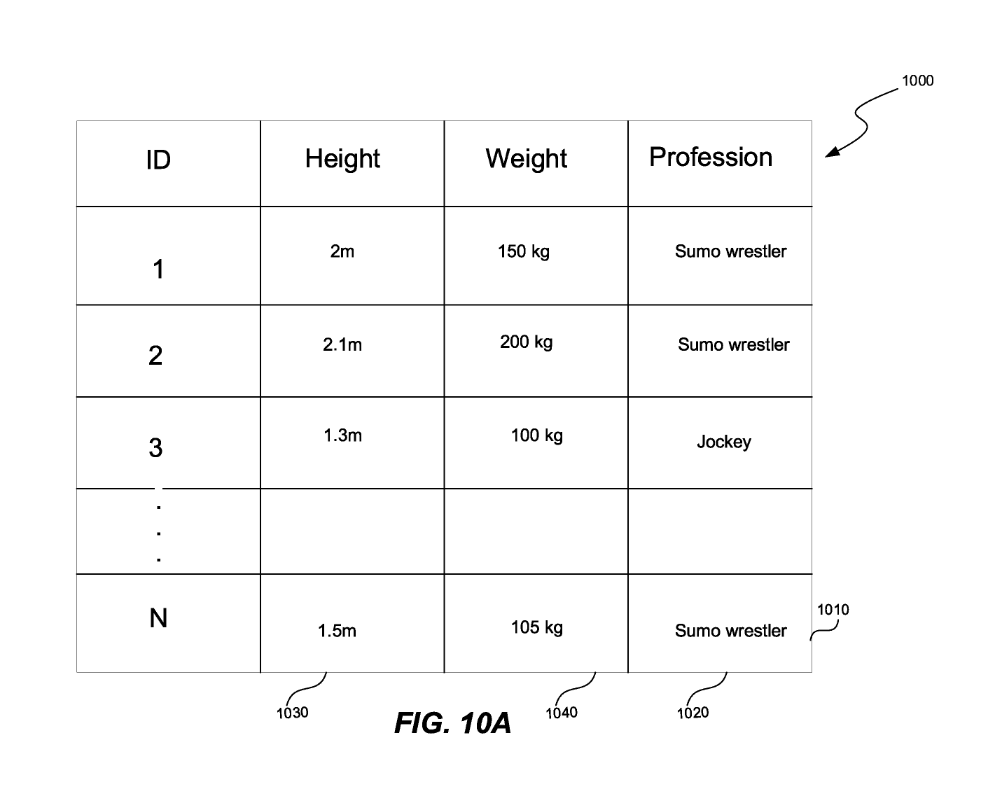

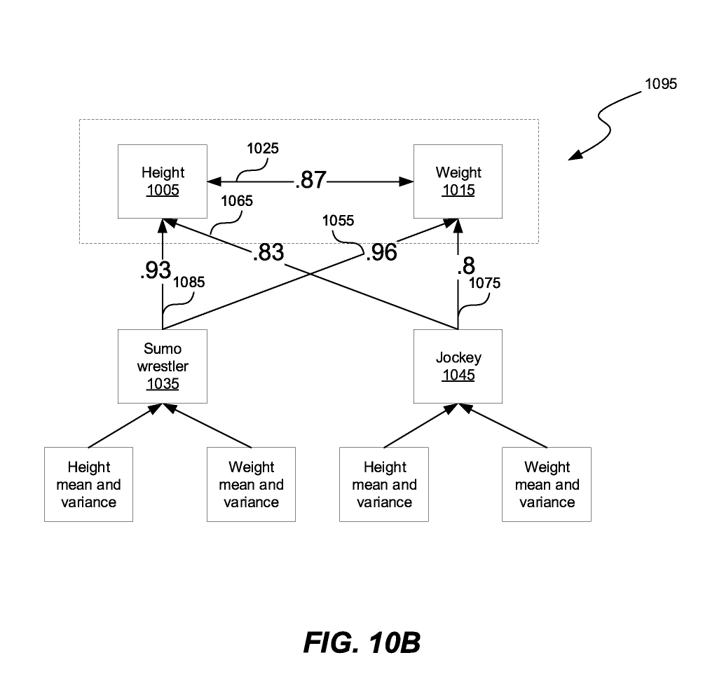

FIG. 10A shows data cleaning and analysis performed by a processor while converting a data set. The table 1000 represents the data set containing questions of height, weight, and profession. The processor can compute mean and variance for height and weight. Based on the mean and variance, the processor can detect node 1010 is being more than a single standard deviation away from the mean of height and weight for sumo wrestlers. Consequently, the processor can delete node 1010, or correct node 1010. To correct the node, the processor can change the profession answer 1020 to “jockey,” or replace the height answer 1030 and the weight answer 1040 with the mean height and mean weight of a sumo wrestler. In addition, the processor can merge two independent data sets by adding new variables to the first data sets, or by combining overlapping variables between the two data sets.

FIG. 10B shows a hierarchical graph 1095, generated based on FIG. 10A and the measured associations between nodes 1005, 1015, 1035, 1045. The hierarchical relationship is represented by a directed graph 1095. Each node 1005, 1015 in the graph can represent a variable or an answer to a variable of categorical type. Each connection 1025 between nodes 1005, 1015 has a weight representing the association between the two nodes. The weights, as described in this application can vary between −1 and 1 inclusive.

For example, the input data contains answers to the questions of height, weight, and profession. Height and weight are continuous variables and they are represented by nodes 1005 and 1015 in the graph 1095. Node 1005 represents height of the respondents, while node 1015 represents weight of the respondents. Profession is a categorical variable, and is represented by nodes 1035, 1045 associated with the answers to the question of profession.

In addition to calculating associations between profession and height, and profession and weight, the processor can calculate associations between answers to categorical variables and other variables, or other categorical variable answers. For example, the processor can calculate the association between profession answer “sumo wrestler” and height, “sumo wrestler” and weight, and association between “jockey” and height, and “jockey” and weight. These associations are represented by connections 1055, 1065, 1075, 1085 in graph 1095.

Once the processor computes associations between all the nodes, when associations are below certain threshold, the associations are either labeled as 0 or removed from the graph. The threshold for removal from the graph can be between −0.2 and 0.2. In other words, any associations that are less than or equal to 0.2 and greater than or equal to −0.2 are removed from the graph. When a node in the graph does not have relationships with any other nodes in the graph, the node is removed. For example, the data set has other job categories, such as a schoolteacher. The category schoolteacher does not appear in the final network because schoolteachers are randomly associated with height and weight, i.e., knowing that someone is a schoolteacher does not provide any additional information about an individual's height and weight.

The processor can calculate the mean and the variance of a continuous variables, i.e., node 1005, 1015, that have an association with a categorical answer 1035, 1045. For example, the processor can compute the mean and the variance of the height and weight of a sumo wrestler and mean and the variance of the height and weight of a jockey as shown in FIG. 10B.

The canonical data model can be the hierarchical graph 1090. The processor can detect a subset of nodes 1005, 1015 in the canonical data model having a significant association 1025, 1085, 1055, 1065, 1075, such as above 0.8, or less than −0.8. In FIG. 10B the association is 1, which is above the 0.8 threshold. When the significant association 1025, 1085, 1055, 1065, 1075 has been detected, the processor can indicate a causal relationship between the subset of nodes. For example, nodes 1005 and 1015 in FIG. 10B have a correlation of 0.87, which exceeds the threshold of 0.8. The processor can indicate that the nodes 1005 and 1015 have a causal relationship.

Further, the database can store one or more of the causal relationships, and in the survey design stage, if the survey designer enters 1 of the variables associated with the nodes 1005 and/or 1015, the processor can suggest to also gather data for the other node. For example, the processor can determine at least one pair of variables that have the association in a second predetermined range, such as the absolute value of the association is greater than or equal to 0.8. The processor can suggest a method of collecting data which includes jointly collecting the value of the first variable in the value of the second variable. In the example of FIG. 10B, the processor can notice a high correlation between height and weight, and suggest collecting height and weight in further questionnaires.

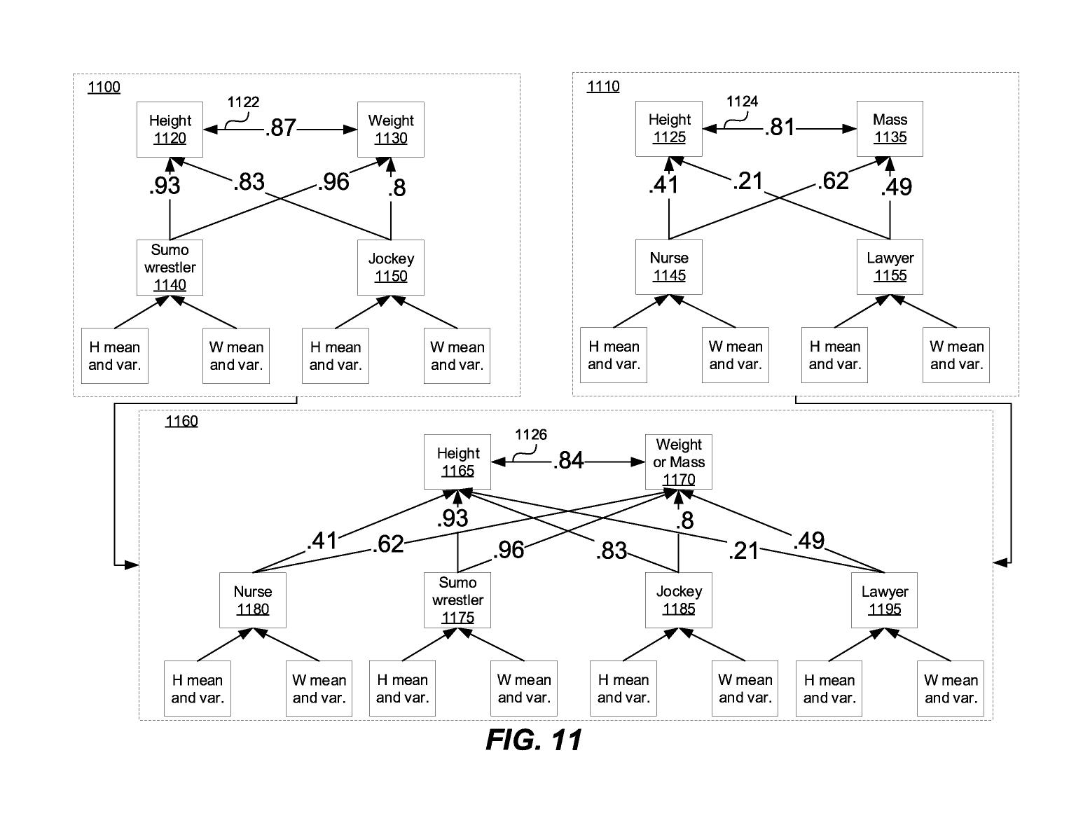

FIG. 11 shows merging of two graphs based on graph connectivity. The two graphs 1100, 1110 can be portions of a larger graph. The two graphs 1100, 1110 have the same connections, but different variable names, and different association between the nodes. Graph 1100 contains the nodes 1120, 1130, 1140, 1150, while graph 1110 contains the nodes 1125, 1135, 1145, 1155. The processor can determine, based on the connections, that the nodes 1120, 1130, 1140, 1150 correspond to the nodes 1125, 1135, 1145, 1155, respectively. Consequently, the processor can merge the graphs 1100, 1110, into the graph 1160.

In graph 1160, continuous nodes 1120, 1125 are represented by a continuous node 1165, continuous nodes 1130, 1135 represented by a continuous node 1170, which contains both variable names “weight” and “mass.” The continuous nodes 1165, 1170 and graph 1116, have association 1126, which has a different magnitude than the corresponding associations 1122, 1124 and graphs 1100, 1110. The values of the categorical nodes 1140, 1150, 1145, 1155 are not combined, and each categorical node is represented by a corresponding node 1175, 1180, 1185, 1190, in graph 1160.

In addition, a magnitude of association 1122, 1124 between two nodes can be used to determine whether two graphs 1100, 1110 should be merged together. For example, if the magnitude of the associations 1122, 1124 between two nodes are within 20% of each other, then the nodes and the connections should be merged together. In the present case, the magnitude of the connection 1122 is 0.87 and the magnitude of connection 1124 is 0.81 which is 6.8% of each other. Thus, the nodes 1120, 1130 and nodes 1125, 1135 should be merged together.

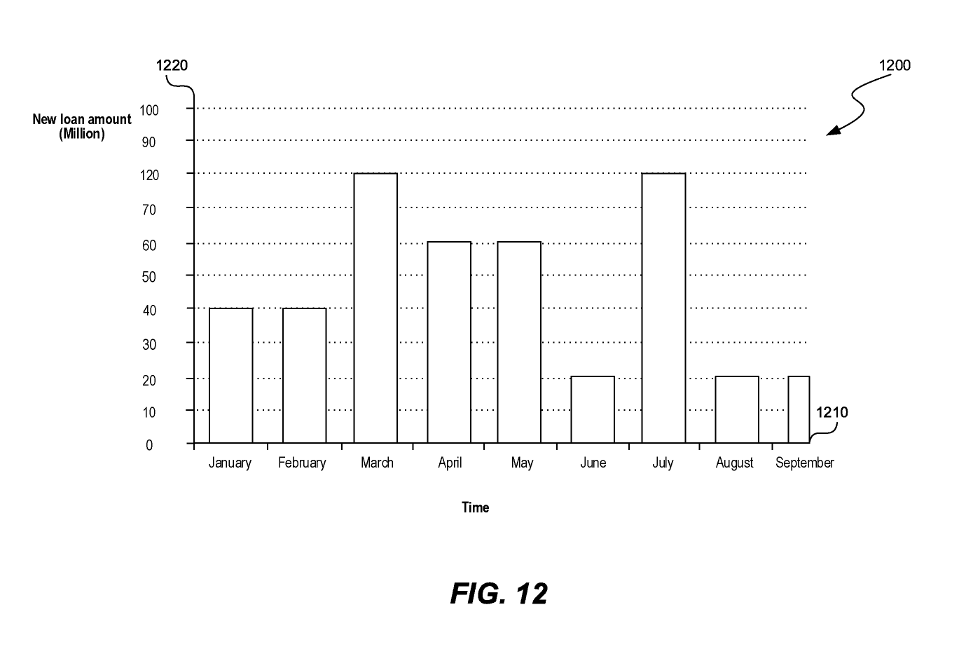

FIG. 12 shows an analysis performed on the data set. The analysis can represent relationships between various variables as a graph, such as a histogram 1200. Histogram 1200 can show relationship between two variables such as time 1210 and loan amount 1220. Relationship between other variables can be shown as well, such as between education and marital status, education and profession, education and loan amount, etc.

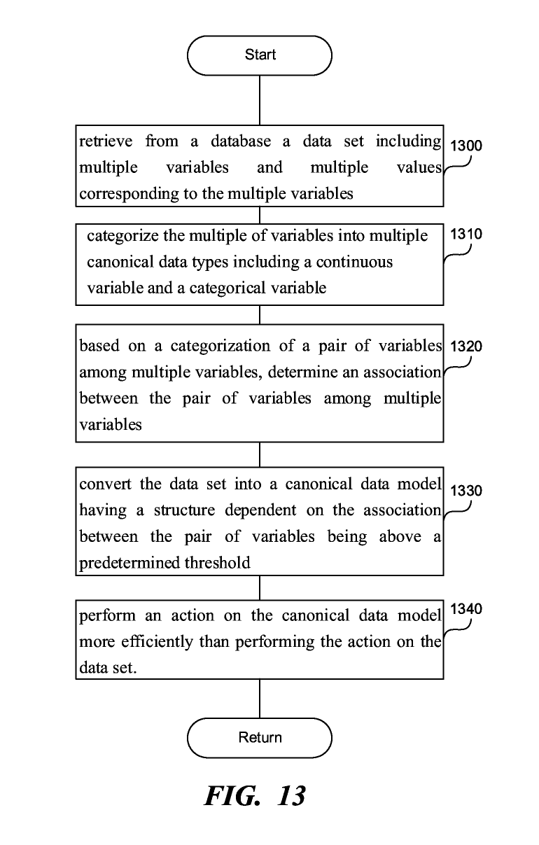

FIG. 13 is a flowchart of a method to convert a data set into a canonical data model, and efficiently perform an action on the data set, according to one embodiment. In step 1300, a processor can retrieve from a database a data set including multiple variables and multiple values corresponding to the variables. In step 1310, the processor can categorize the variables into multiple canonical data types including a continuous variable and a categorical variable. The continuous variable can be a variable having a number of values above a predetermined threshold, and the categorical variable can be a variable having a number of values below a predetermined threshold.

In step 1320, based on a categorization of a pair of variables among multiple variables, the processor can determine an association between the pair of variables among multiple variables, where the association can indicate a relationship between a value of a first variable in the pair of variables and a value of a second variable in the pair of variables. Association is usually measured by correlation for two continuous variables and by cross tabulation and a Chi-square test for two categorical variables.

In step 1330, the processor can convert the data set into a canonical data model having a structure dependent on the association between the pair of variables being above a predetermined threshold. The structure can be a matrix, a bi-directional graph, a directed graph, a directed acyclic graph, hierarchical, etc. the conversion to the canonical data model can be performed as a pre-computation step, and the canonical data model can be stored for later use. For example, the conversion into the canonical data model can be performed initially before an action needs to be performed on the data set. Once the processor receives the action to perform, such as generate an analysis shown in FIG. 12, or compute minimum and maximum of one or more variables, the processor can retrieve the stored canonical data model, and perform the action on the canonical data model.

In step 1340, the processor can perform the action on the canonical data model more efficiently than performing the action on the data set by avoiding an analysis of the pair of variables having the association below the predetermined threshold. For example, the processor can perform lossy or lossless compression on the canonical data model, thus reducing the number of variables and/or values that need to be analyzed. Performing the action on the compressed canonical data model, where unnecessary associations have been deleted, values have been averaged, and/or variables have been deleted, is faster than performing the same action on the original data set, because there is less information to process while performing the action. In another example, the processor can clean the data model of spurious data such as outliers, incorrectly recorded data, etc. before generating the canonical data model. Consequently, the canonical data model only contains clean data, and performing the action on the canonical data model is faster because the canonical data model contains less data than the data set, and because no processing style is needed to account for spurious data.

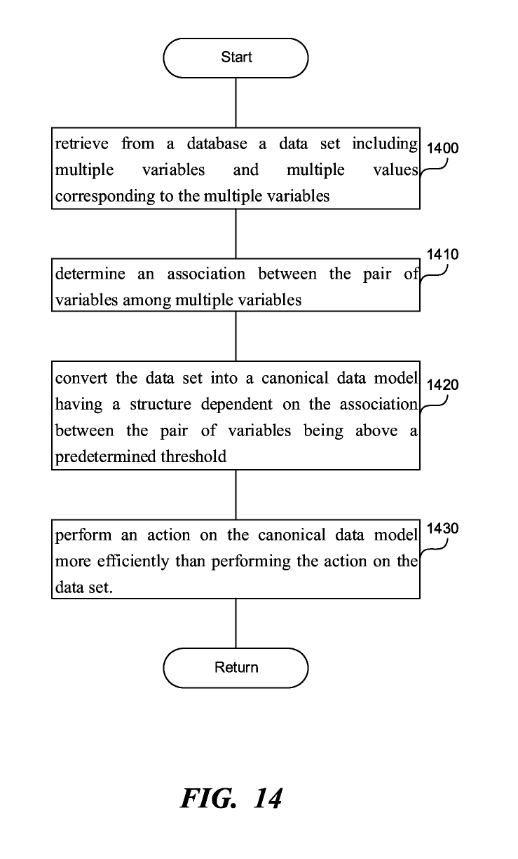

FIG. 14 is a flowchart of a method to convert a data set into a canonical data model, and efficiently perform an action on the data set, according to one embodiment. In step 1400, processor can retrieve, from a database, a data set including multiple variables and multiple values corresponding to the multiple variables.

In step 1410, the processor can determine an association between a pair of variables among multiple variables. The association can indicate a relationship between a value of a first variable in the pair of variables and a value of a second variable in the pair of variables. Association can be measured as described in this application.

In step 1420, the processor can convert the data set into a canonical data model having a structure dependent on the association between the pair of variables being above a predetermined threshold. The canonical data model can include multiple nodes representing the multiple variables, multiple connections between the pair of nodes among multiple nodes, the multiple connections representing the association between the pair of nodes representing the pair of variables, and multiple weights associated with the multiple connections, the multiple weights representing the association between the pair of variables represented by the pair of nodes.

In step 1430, the processor can perform an action on the canonical data model more efficiently than performing the action on the data set by avoiding an analysis of the pair of variables having the association below the predetermined threshold, as described in this application.

The processor can categorize the multiple variables into multiple canonical data types including a continuous variable, a categorical variable, open response, location data, time-based data, yes/no data, image, audio, video, 3-dimensional model data, etc.

The processor can clean the canonical data model of spurious data. For example, the processor can detect a significant variation in a variable categorized as the continuous variable. The processor can smooth the significant variation based on a value of the variable proximate to the significant variation. In a more specific example, the processor can smooth the significant variation by averaging values neighboring the significant variation, or by performing a low-pass filter. In another example, the processor can perform the cleaning based on relationships. The processor can detect a variable in the pair of variables having an inconsistently present value, such as “number of TV sets” in FIG. 9A. Based on a present value of the variable determining a replacement value, such as determining in FIG. 9A that the present value of the variable is 0, and replacing the inconsistently present value with the replacement value. Alternatively, as shown in FIG. 9C, after checking the structure of the questionnaire, the processor can determine that the correct replacement value is “N/A.” As another alternative, the processor can replace the inconsistently present value, i.e., the missing value, with the mode of the variable, the average of the variable, etc.

To create the canonical data model, the processor can create a first node in the canonical data model representing a continuous variable, and a second node representing a value of a categorical variable. The processor can create a third node in the canonical data model representing at least one of a mean or a variance of the continuous variable, and can establish a connection between the third node and the first node. The connection representing an association between the third node in the first node can have a weight of 1, indicating a linear dependence between mean and/or variance and a value of the continuous variable.

An action to perform can be merging of two disparate data sets. To merge the data sets, the processor can obtain a second canonical data model from a second data set. The processor can determine corresponding variables between the data set and the second data set based on the structure of the canonical data model and the second structure of the second canonical data model, as described in FIG. 11. The processor can determine corresponding variables between the data set and the second data set based on similarity of values between continuous and categorical variables, connectivity between nodes as shown in FIG. 11, and/or magnitude of association between nodes. The processor can also determine the corresponding variables based on variable names. For example, in FIG. 11 the two nodes 1120, 1125 have the same variable name “height”. Based on the variable name, the processor can determine that the two nodes 1120, 1125 in the two graphs 1100, 1110 correspond to each other. Further, even if two nodes do not have the identical variable name, the processor can identify symptoms. For example, in FIG. 11, two nodes 1130, 1135 have names “weight” and “mass”, which can be synonyms. Thus, the processor can determine that the two nodes 1130 and 1135 correspond to each other. Finally, the processor can merge the corresponding variables in the data set and the second data set into a merged graph 1160 in FIG. 11.

An action to perform can be compressing the data set. Performing lossless or lossy compression on the initial output data, as shown in FIGS. 3, 4B, 5C, 8B-8C reduces the size of the data set, as shown in FIGS. 2, 5A, 8A, and thus reduces the memory footprint of the canonical data model as compared to the data set. Reducing the memory footprint results in more efficient storage, and faster transmission of data across a network. The compression can be performed by avoiding repeating the same value of a variable, approximating a value of a continuous variable with a function and/or procedurally, approximating a value of a continuous variable with a linear interpolation between sampled values, low correlation compression, high correlation compression, etc.

In low correlation compression, processor can detect a node in the canonical data model having an insignificant association with substantially all the rest of the multiple nodes in the canonical data model. For example, the processor can detect a node having an insignificant association, such as an absolute value of the magnitude of association below 0.2, with substantially all the rest of the nodes, such as 90% or more of the rest of the nodes. The processor can compress the canonical data model by deleting the node. The processor can compress the value of the node using lossy compression because the node is not highly relevant to the canonical data model, and lossy compression tends to produce higher compression than lossless compression. To perform the lossy compression, the processor can also compress a value of a variable associated with the node by representing substantially identical values as a single value. For example, the processor can determine that values within 0.9% of each other are the same values, and represent them with a single value, or by averaging all the values. The processor can also average the value of the variable, and represent the variable with the average.

In high correlation compression, the processor can detect a node in the canonical data model having a significant association with a second node in the canonical data model. The significant association can be an absolute value of the magnitude of the association is above 0.8. The processor can compress the value of a variable associated with the node by representing the value of the node as a function of a second value associated with the second node. For example, when the absolute value of the magnitude of the association between the node and the second node is 1, the node in the second node can have a linear relationship. To perform the compression, the processor can determine the quotient offset of the linear relationship, and express a value of 1 of the nodes is a linear function of the value of the other node.

An action to perform can be efficiently converting between two data sets. The processor can obtain the stored canonical data model of the data set. As explained in this application, the canonical data model as already been optimized in terms of size and representation, cleaned of spurious data, etc. and can be more efficiently converted into a second data set than the data set. The processor can obtain the second data set and performance of the second data set such as a flat database, a relational database, a hierarchical database, etc. The processor can convert the canonical data model into the format of the second data set more efficiently than converting the data set into the second data set because the canonical data model is smaller in size than the data set, has been cleaned of spurious data and/or insignificant relationships, and is represented in more compact way.

### Hierarchical Data Model

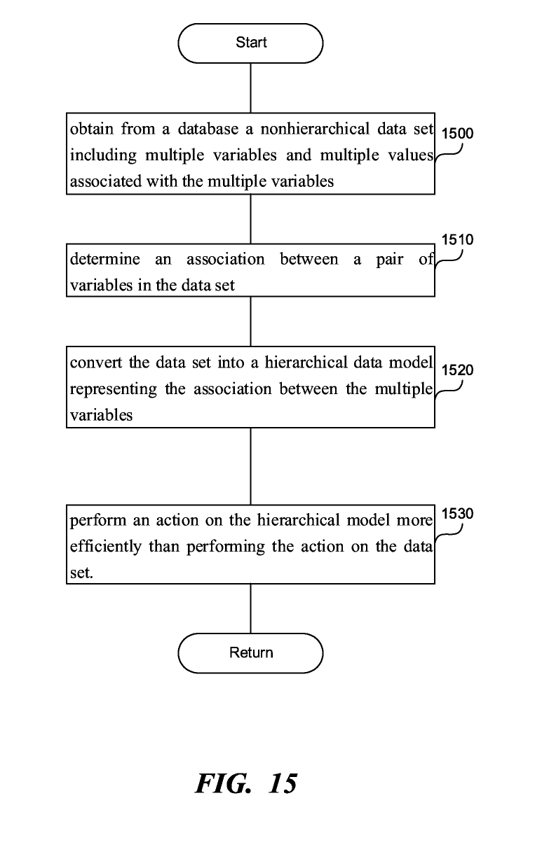

FIG. 15 is a flowchart of a method to efficiently perform an action on a nonhierarchical data set by constructing a hierarchical data model, according to one embodiment. In step 1500 the processor can obtain from a database the nonhierarchical data set which can include multiple variables and multiple values associated with the multiple variables. The nonhierarchical data set can have various formats such as sing a flat database, a relational database, or a risk database.

In step 1510, the processor can determine an association between a pair of variables in the data set. The association can be a relationship between a value of a first variable in the pair of variables and a value of a second variable in the pair of variables, as described in this application. The association can be a correlation between the pair of variables.

In step 1520, the processor can convert the data set into a hierarchical data model representing the association between the multiple variables. An association below a predetermined threshold and/or a variable without a significant association with rest of the multiple variables can be left out the hierarchical data model, thus creating a smaller model that is easier to process.

In step 1530, the processor can perform an action on the hierarchical data model more efficiently than performing the action on the data set by avoiding processing the association below the predetermined threshold and by avoiding processing the variable without the significant association with rest of the multiple variables.

The conversion into the hierarchical data model can be performed as a pre-computation step, and the hierarchical data model can be stored in a database. Once request to perform an action is received, the processor can provide a hierarchical data model, and perform the action of the hierarchical data model. By storing the hierarchical data model in the database, the cost of performing the corrosion to the hierarchical data model is performed only once, and the subsequent actions in the data set are performed directly on the hierarchical data model.

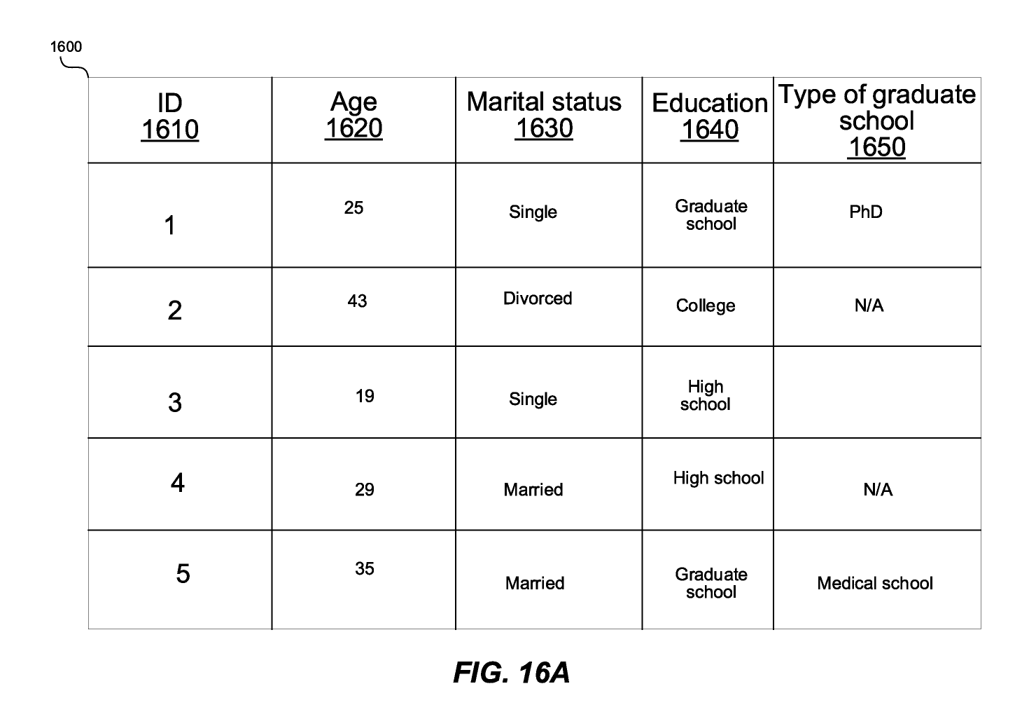

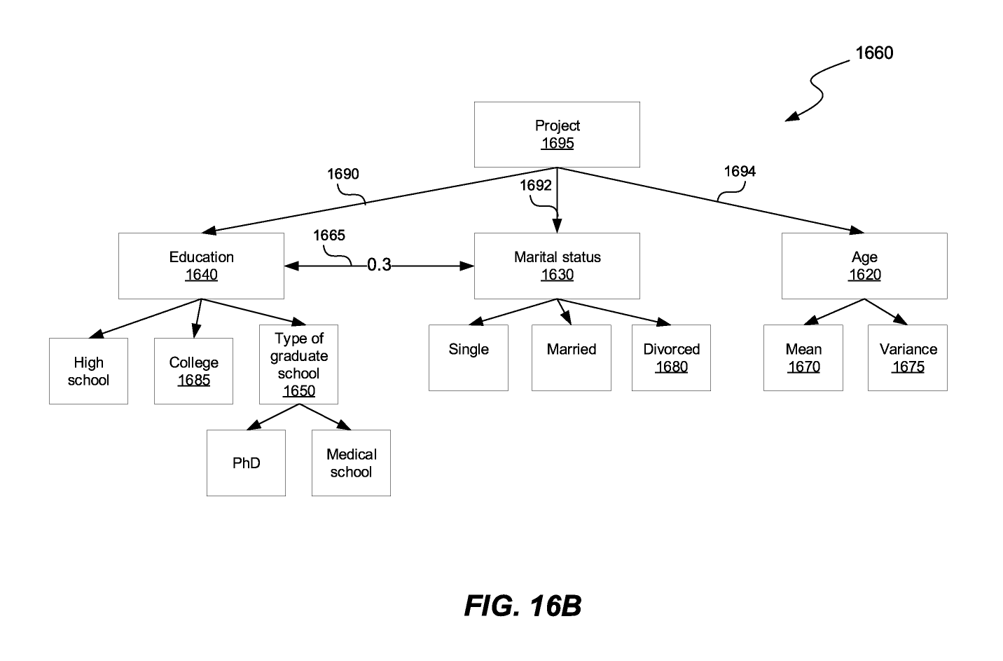

FIGS. 16A-B show a data set and a corresponding hierarchical data model. The data set 1600 in FIG. 16A shows the respondent ID 1610, and various responses 1620, 1630, 1640, 1650 received from the respondent. Variable 1620 corresponds to the age of the respondent, variable 1630 corresponds to the marital status of the respondent, variable 1640 corresponds to adjudication of the respondent, and variable 1650 corresponds to the type of higher education. Variable 1650 depends on the value of the variable 1640. Specifically, when the value of the variable 1640 is “graduate school”, the question associated with variable 1650 can be asked, namely, “type of graduate school.” The dependency of variables 1650 on the value of the variable 1640 can be represented with a hierarchical relationship, as shown in FIG. 16B.

The hierarchical data model 1660 in FIG. 16B can be built by removing insignificant relationships, insignificant nodes, mean and variance for continuous variables, values of categorical variables, structure of the questionnaire, etc. For example, to remove insignificant relationships, the processor can calculate the association between education and marital status to be 0.3, the association between education and age to be 0.12, while the association between marital status and age can be 0.05. The processor can remove associations below a predetermined threshold such as less than 0.15. Consequently, in the hierarchical data model 1660 in FIG. 16B, the association between education and age, and association between marital status and age is not represented, while the relationship between education and marital status is represented by the relationship 1665.

The mean and variance 1670, 1675 of the continuous variable age 1620 are represented as children of the continuous variable 1620 in the hierarchical data model 1660. Values of categorical variables 1680, 1685 (only two labeled for brevity) are also represented as children of their respective categorical variables 1630, 1640. The dependence of variable 1650 on the value of the variable 1640 is also hierarchical and represented in the hierarchical data model 1660 by making the variable 1650 a child of the variable 1640. The dependence of the variable 1651 and variable 1640 can be reflected in the structure of the questionnaire. The hierarchical data model 1660 can also have a hierarchical relationship 1690, 1692, 1694 to a project 1695 in the database.

Value dependence of two variables can be detected and created into a hierarchy even in a situation where there is no explicit dependence of two questions in the structure of the questionnaire. For example, variable X can have values 1, 2, 3. Variable Y can have a value A when X has a value of 1, and B when variable X has a value of 2. The processor can detect the dependence between the values, and can create a graph where a node X, which is a parent of a node having a value of 1, which is a parent of a node Y=A. Similarly, the node X can be a parent of a node having a value of 2, which is a parent of a node having a value of Y=B.

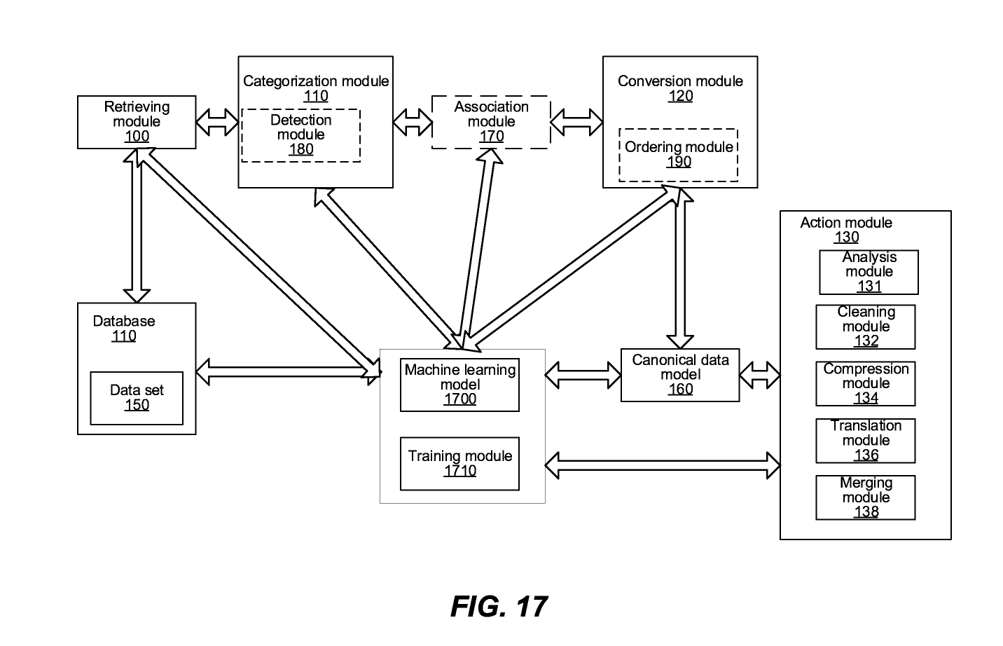

FIG. 17 shows a system to efficiently perform an action on a data set using a machine learning model. The machine learning model 1700 can be trained using a training module 1710. The machine learning model 1700 and the training module 1710 can interface with the system described in FIG. 1. The machine learning model 1700 and/or the training module 1710 can receive a data set 150 from the retrieving module 100 or from the database 140. Further, the machine learning model 1700 and/or the training module 1710 can receive a processed data set from the categorization module 110 after the variables within the data set have been categorized, from the association module 170 after the association between the variables has been determined, and/or the conversion module 120. The machine learning model 1700 can output the canonical data model 160, which can be the hierarchical data model. The machine learning model 1700 can also perform various actions performed by the action module 130.

The training module 1710 can train the machine learning model 1700 to receive the nonhierarchical data set, such as data set 150, and produce the hierarchical data model. The training module 1710 can receive, from the database 140, or a different database, the various training sets used in training a machine learning model 1700. The machine learning model 1700 can convert the data set 150 into the hierarchical data model. The machine learning model 1700 can perform the function of the categorization module 110, association module 170, conversion module 120, and/or action module 130.

The training module 1710 can obtain a variable hierarchy defined at a collection stage associated with the data set, the variable hierarchy defining a relationship between a first variable among multiple variables and a second variable among multiple variables, as described in FIG. 16. The training module 1710 can obtain the hierarchical data model based on the variable hierarchy. The training module 1710 can train the machine learning model 1700 using the data set as input and the hierarchical data model as a desired output.

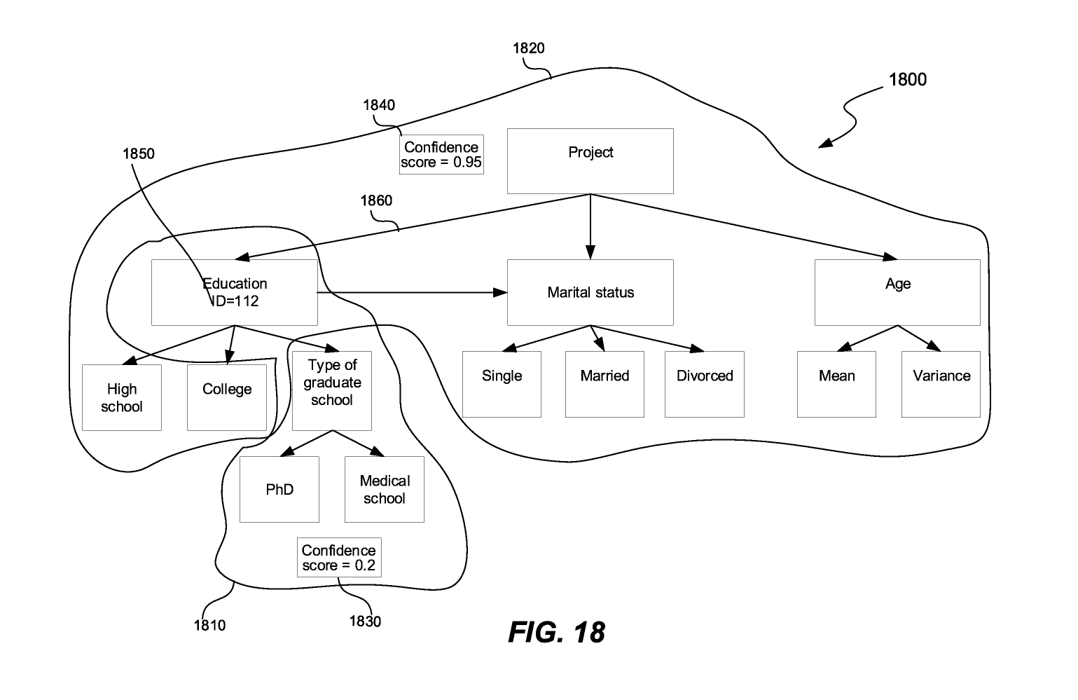

The machine learning model 1700 can provide confidence scores for portions of the hierarchical data model, such as nodes or sub graphs of the hierarchical data model. The confidence score can indicate the confidence level of the machine learning model 1700 in the accuracy of the portion of the hierarchical data model. For example, the machine learning model 1700 can identify the portion of the hierarchical data model using node identifiers (IDs) and relationship IDs, and associate the portion of the hierarchical data model to a confidence score having a value in predetermined rage, such as 0 to 1, as further explained in FIG. 18. For example, confidence score of 0.9 would indicate a high confidence level, and a confidence score of 0.02 would indicate a low confidence level.

The training module 1710 can identify a portion of the hierarchical data model where the machine learning model produces a low confidence score, below a predetermined threshold, such as 0.2. The training module 1710 can query the user for feedback about an accuracy of the portion of the hierarchical data model having the low confidence score. The query can ask the user whether the portion of the hierarchical data model is accurate, and if not, to provide the accurate representation of the portion of the hierarchical data model.

The conversion module 120 can convert the data set 150 into a hierarchical data model representing the association between the multiple variables by creating the hierarchical data model based on a dependency of values between the pair of variables. An association below a predetermined threshold can be left out of the hierarchical data model, and/or a variable without a significant association with rest of the multiple variables are left out the hierarchical data model. The data set 150 can be a nonhierarchical data set such as a flat database, a relational database, or a risk database. The conversion into the hierarchical data model can be performed as a pre-computation step, as described in this application.

To create the hierarchical data model by leaving out associations below a predetermined threshold, the conversion module 120 can obtain the predetermined threshold, such as 0.1, and remove the association between variables below the predetermined threshold, thereby creating the hierarchical data model.

To create the hierarchical data model based on variable dependence and/or structure of the questionnaire, the conversion module 120 can obtain a variable hierarchy defined at a collection stage. The defined variable hierarchy can be a criterion defining the relationship between two variables. The conversion module 120 can create the hierarchical data model based on the variable hierarchy.

The criterion can define the relationship such as only asking the question about the type of graduate school if level of education includes graduate school, as described in FIGS. 16A-B. The criterion can be that the parent variable has a defined value. The criterion can enable entering the value associated with the variable when a value associated with a parent variable has been entered. The criterion can enable entering the value associated with the variable when a value associated with a parent variable has a predetermined value. The criterion can define a value of a first variable based on a value of a second variable using a piece of code (i.e., procedurally) and/or a mathematical function tying the values of the two variables.

The action module 130 can obtain the hierarchical data model and a format of a second data set, the format comprising at least one of a flat database, a relational database, or a risk database, and can convert the hierarchical data model into the format of the second data set.

FIG. 18 shows confidence scores associated with a hierarchical data model. The hierarchical data model 1800 can be produced by the machine learning model 1700 in FIG. 7. The machine learning model 1700 can tag various portions 1810, 1820 of the hierarchical data model 1800 with various confidence scores 1830, 1840 indicating the confidence level of the machine learning model 1700 in the accuracy of the portion 1810, 1820 of the hierarchical data model. In FIG. 18, the portion 1810 of the hierarchical data model 1800 is a confidence score of 0.2, while the portion 1820 of the hierarchical data model 1800 has a confidence score of 0.95. The portion 1810, 1820 can be identified using node IDs 1850 (only one shown for brevity), and relationship IDs 1860 (only one shown for brevity). The training module 1710 can query the user whether the portion 1810 of the hierarchical data model 1800 is accurate, and if not query the user to provide the accurate representation of the portion 1810. As can be seen in FIG. 18, one node, namely node having node ID 1850, can be a member of multiple portions 1810, 1820 of the hierarchical data model 1800.

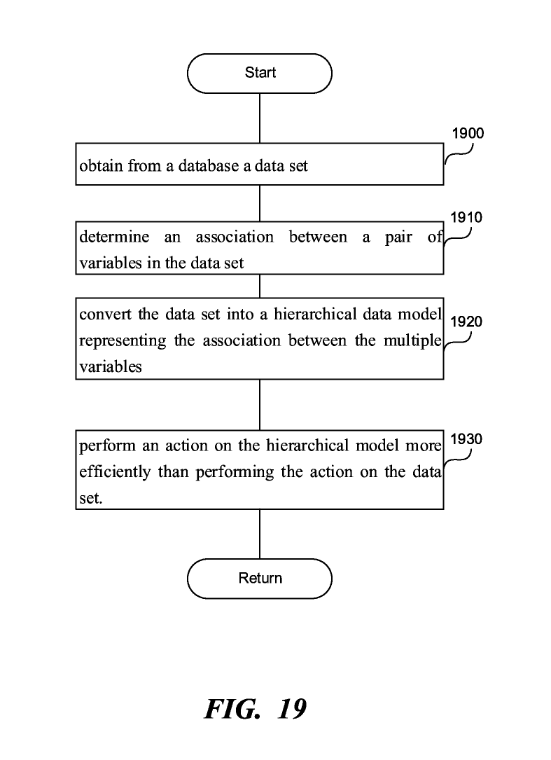

FIG. 19 is a flowchart of a method to efficiently perform an action on a nonhierarchical data set by constructing a hierarchical data model, according to another embodiment. In step 1900, a processor can obtain, from a database, a data set including multiple variables and multiple values associated with the multiple variables. The data set can be nonhierarchical data set such as a flat database, a relational database, or a risk database.

In step 1910, the processor can determine an association between a pair of variables in the data set, where the association can indicate a relationship between a value of a first variable in the pair of variables and a value of a second variable in the pair of variables. Association can be correlation as explained in this application.

In step 1920, the processor can convert the data set into a hierarchical data model representing the association between the multiple variables by creating the hierarchical data model based on a dependency of values between the pair of variables, as explained this application. For example, a first variable can be represented as a procedural function or a mathematical function of a second variable. In such a case, the second variable is the parent, and the first variable is a child in the hierarchical data model. In another example, the values of the first variable may not even be collected, if the second variable does not have a value. In this example, the second variable can be represented as the parent in the first variable can be represented as the child in the hierarchical data model.

In step 1940 the processor can perform an action on the hierarchical data model more efficiently than performing the action on the data set by avoiding processing the association below the predetermined threshold, and/or by avoiding processing the variable without the significant association with rest of the multiple variables.

The processor can train a machine learning model to receive the nonhierarchical data set and produce the hierarchical data model. The processor can obtain a variable hierarchy defined at a collection stage associated with the data set. The variable hierarchy can define a relationship between the variable among multiple variables and a second variable among multiple variables. The relationship can include a criterion, as described in this application, such as the parent variable has a defined value, the parent variable has a particular value, etc. The processor can create the hierarchical data model based on the variable hierarchy. The processor can train the machine learning model using the data set as input and the hierarchical data model as a desired output.

During the process of training, the processor can identify a portion of the hierarchical data model where the machine learning model produces a low confidence score, and can query the user about an accuracy of the portion of the hierarchical data model, as described in FIGS. 17-18. For example, the input data set can be a legacy data set that needs to be imported into a new database format. During the conversion process, the processor can query the user for correct connections and labels in the hierarchical data model. As a result, the hierarchical data model can represent a large set of labeled complex data structures.

The processor can obtain a variable hierarchy defined at a collection stage associated with the data set. The variable hierarchy can define a relationship between at least two variables. The relationship can include a criterion as described in FIG. 17. The processor can create the hierarchical data model based on the variable hierarchy. The criterion can enable entering the value associated with the variable when a value associated with a parent variable has been entered. The criterion can enable entering the value associated with the variable when a value associated with a parent variable has a predetermined value. For example, entering a number of television sets can only be allowed when a person is not an apartment dweller. The criterion can define a value of a first variable in the at least two variables based on a value of a second variable in the at least two variables. The criterion can be expressed as a piece of code, or as a mathematical function tying the two variables.

The processor can perform an action on the hierarchical data model, such as cleaning the hierarchical data model based on relationships. The processor can detect a variable in the pair of variables having an inconsistently present value. Based on a present value of the variable, the processor can determine a replacement value. For example, the processor can determine a mode, median, or an average of the present values to obtain replacement value. The processor can replace the inconsistently present value with the replacement value.

The processor can merge multiple disparate data sets. The multiple data sets can have different variable names which mean the same thing, as explained in FIG. 11. The processor can obtain the hierarchical data model associated with each data set among the multiple data sets. The processor can determine corresponding variables between the multiple data sets based on the structure of the hierarchical data models. The processor can determine corresponding variables based on similarity of values, connectivity between nodes, association between nodes, variable names, etc. For example, the processor can determine if two variable names are synonyms using a dictionary. The processor can merge the corresponding variables in the hierarchical data model into a merged data set.

The processor can analyze the data set by detecting a subset of nodes among multiple nodes in the hierarchical data model having a significant association. The processor can indicate a causal relationship between the subset of nodes, as described in FIG. 10B.

The processor can compress the data set and reduce the memory footprint of the data sets by replacing the data set with the hierarchical data model. Depending on the structure of the data set, the hierarchical data model can take up between 90% and 10% of the memory of the input data set.

The processor can use low correlation compression to create the hierarchical data model. The processor can detect a node in the hierarchical data model having an insignificant association with substantially all the rest of the multiple nodes in the hierarchical data model. The processor can compress a value of a variable associated with the node by representing substantially identical values as a single value by, for example, averaging the substantially identical values.

The processor can use high correlation compression to create the hierarchical data model. The processor can detect a node in the hierarchical data model having a significant association with a second node in the hierarchical data model. The processor can compress the value of a variable associated with the node by representing the value of the node as a function of a second value associated with the second node. The function can be procedural (i.e., a piece of code), linear, or nonlinear such as polynomial, sinusoidal, etc.

The processor can perform an action such as efficiently converting the data set into a second data set. The processor can obtain the hierarchical data model thus avoiding the expense of computing the hierarchical data model, repeatedly. The processor can obtain a format of a second data set, such as a flat database, a relational database, or risk database. The processor can convert the hierarchical data model into the format of the second data set.

The processor can perform the action such as suggesting a method of collecting data. The processor can determine at least one pair of variables having the association in a second predetermined range. The second predetermined range can indicate a high association, such as above 0.8, or a low association, such as below 0.2. High association can indicate that the value of the first variable in the pair of variables has a high influence on the value of the second variable in the pair of variables. The influence can be linear. Low association can indicate the values of the two variables are not related to each other. The processor can suggest the method of collecting data such as collecting the value of the first variable and the value of the second variable.

### Computer

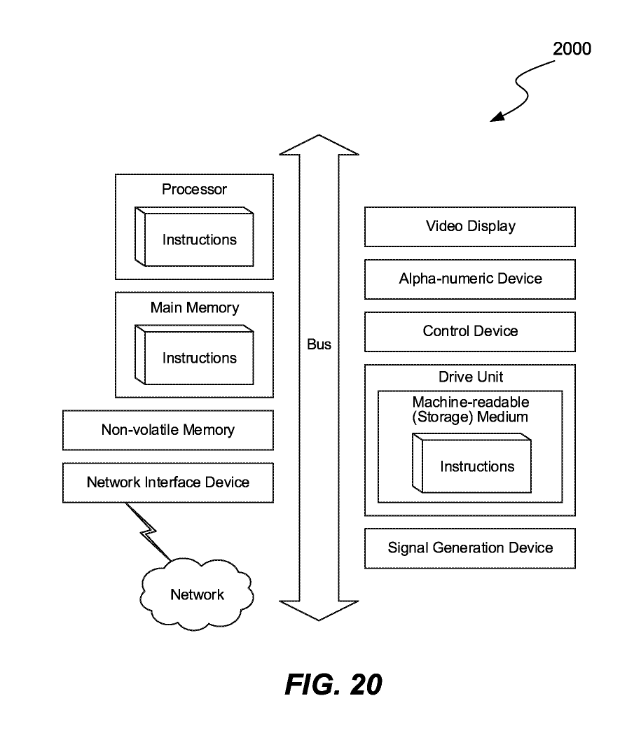

FIG. 20 is a diagrammatic representation of a machine in the example form of a computer system 2000 within which a set of instructions, for causing the machine to perform any one or more of the methodologies or modules discussed herein, may be executed.

In the example of FIG. 20, the computer system 2000 includes a processor, memory, non-volatile memory, and an interface device. Various common components (e.g., cache memory) are omitted for illustrative simplicity. The computer system 2000 is intended to illustrate a hardware device on which any of the components described in the example of FIGS. 1-19 (and any other components described in this specification) can be implemented. The computer system 2000 can be of any applicable known or convenient type. The components of the computer system 2000 can be coupled together via a bus or through some other known or convenient device.

The processor of the computer system 2000 can be the processor executing the various instruction described this application. The processor can execute instructions associated with the retrieving module 100, categorization module 110, detection module 180, association module 170, conversion module 120, ordering module 190, action module 130 including analysis module 131, cleaning module 132, compression module 134, translation module 136, merging module 138 in FIG. 1, as well as the machine learning model 1700 and training module 1710 in FIG. 17.

The database 140 in FIG. 1 can be implemented on the computer system 2000. The database 140 can communicate with the rest of the system in FIG. 1 using the network interface and the network in FIG. 20. The database 140 can be stored within the drive unit, the main memory and/or the nonvolatile memory in FIG. 20. The processor performing the conversion between data sets can be the processor of the computer system 2000. The machine learning model used to communicate between disparate data sets can be trained on the computer system 2000. The main memory, the nonvolatile memory, and/or or the drive unit of computer system 2000 can store the canonical data model and/or the hierarchical data model as described in this application.

This disclosure contemplates the computer system 2000 taking any suitable physical form. As example and not by way of limitation, computer system 2000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 2000 may include one or more computer systems 2000; be unitary or distributed; span multiple locations; span multiple machines; or reside in a cloud, which may include one or more cloud components in one or more networks. Where appropriate, one or more computer systems 2000 may perform, without substantial spatial or temporal limitation, one or more steps of one or more methods described or illustrated herein. As an example and not by way of limitation, one or more computer systems 2000 may perform, in real time or in batch mode, one or more steps of one or more methods described or illustrated herein. One or more computer systems 2000 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 2000. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing an entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 2000. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 20 reside in the interface.

In operation, the computer system 2000 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the machine and that cause the machine to perform any one or more of the methodologies or modules of the presently disclosed technique and innovation.

In general, the routines executed to implement the embodiments of the disclosure may be implemented as part of an operating system or a specific application, component, program, object, module, or sequence of instructions referred to as “computer programs.” The computer programs typically comprise one or more instructions set at various times in various memory and storage devices in a computer and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A method comprising:
retrieving from a database, a data set comprising a plurality of variables and a plurality of values corresponding to the plurality of variables;
categorizing the plurality of variables into a plurality of canonical data types comprising a continuous variable and a categorical variable, wherein the continuous variable comprises a variable having a number of values above a first predetermined threshold, and wherein the categorical variable comprises a variable having a number of values below a second predetermined threshold;
based on a categorization of a pair of variables in the plurality of variables, determining an association between the pair of variables in the plurality of variables, the association indicating a relationship between a value of a first variable in the pair of variables and a value of a second variable in the pair of variables;
converting the data set into a canonical data model having a structure dependent on the association between the pair of variables being above the first predetermined threshold; and
avoiding an analysis of the pair of variables having the association below the second predetermined threshold, wherein an action is performed on the canonical data model more efficiently than performing the action on the data set.

2. A method comprising:
retrieving from a database, a data set comprising a plurality of variables and a plurality of values corresponding to the plurality of variables;
determining an association between a pair of variables in the plurality of variables, the association indicating a relationship between a value of a first variable in the pair of variables and a value of a second variable in the pair of variables;
converting the data set into a canonical data model having a structure dependent on the association between the pair of variables being above a first predetermined threshold; and
performing an action on the canonical data model more efficiently than performing the action on the data set by avoiding an analysis of the pair of variables having the association below the first predetermined threshold.

3. The method of claim 2, the canonical data model comprising a plurality of nodes representing the plurality of variables, a plurality of connections between a pair of nodes in the plurality of nodes, the plurality of connections representing the association between the pair of nodes representing the pair of variables, and a plurality of weights associated with the plurality of connections, the plurality of weights representing the association between the pair of variables represented by the pair of nodes.

4. The method of claim 2, the method comprising:
categorizing the plurality of variables into a plurality of canonical data types comprising a continuous variable and a categorical variable, wherein the continuous variable comprises a variable having a number of values above the first predetermined threshold, and wherein the categorical variable comprises a variable having a number of values below a second predetermined threshold.

5. The method of claim 4, said performing the action comprising:
cleaning the canonical data model of spurious data by detecting a significant variation in the variable categorized as the continuous variable; and
smoothing the significant variation based on a value of the variable proximate to the significant variation.

6. The method of claim 2, said converting the data set into the canonical data model comprising:
creating a first node in the canonical data model representing a continuous variable; and
creating a second node in the canonical data model representing a value of a categorical variable.

7. The method of claim 6, comprising:
creating a third node in the canonical data model representing at least one of a mean or a variance of the continuous variable; and
establishing a connection between the third node and the first node.

8. The method of claim 2, said performing the action comprising cleaning the canonical data model of spurious data, said cleaning comprising:
detecting a variable in the pair of variables having an inconsistently present value;
based on a present value of the variable determining a replacement value; and
replacing the inconsistently present value with the replacement value.

9. The method of claim 2, said performing the action comprising merging a plurality of disparate data sets, said merging comprising:
obtaining a second canonical data model from a second data set;
determining corresponding variables between the data set and the second data set based on the structure of the canonical data model and a second structure of the second canonical data model; and
merging the corresponding variables in the data set and the second data set into a merged data set.

10. The method of claim 9, said determining corresponding variables comprising:
determining the corresponding variables based on similarity of values associated with a variable in the plurality of variables and the second variable in a second plurality of variables associated with the second canonical data model, or similarity of connectivities between a node in the canonical data model corresponding to the variable and a node in the second canonical data model corresponding to the second variable.

11. The method of claim 2, said performing the action comprising analyzing the data set, said analyzing comprising:
detecting a subset of nodes in a plurality of nodes in the canonical data model having a significant association; and
indicating a causal relationship between the subset of nodes.

12. The method of claim 2, said performing the action comprising compressing the data set, said compressing comprising:
reducing a memory footprint of the data set by replacing the data set with the canonical data model.

13. The method of claim 2, said performing the action comprising compressing the data set, said compressing comprising:
detecting a node in the canonical data model having an insignificant association with substantially all the rest of a plurality of nodes in the canonical data model; and
compressing a value of a variable associated with the node by representing substantially identical values as a single value.

14. The method of claim 2, said performing the action comprising compressing the data set, said compressing comprising:
detecting a node in the canonical data model having a significant association with a second node in the canonical data model; and
compressing the value of a variable associated with the node by representing the value of the node as a function of a second value associated with the second node.

15. The method of claim 2, said performing the action comprising efficiently converting between two data sets, said efficiently converting comprising:
obtaining the canonical data model and a format of a second data set, the format comprising at least one of a flat database, a relational database, or a hierarchical database; and
converting the canonical data model into the format of the second data set.

16. The method of claim 2, said performing the action comprising suggesting a method of collecting data, said suggesting comprising:
determining at least one pair of variables having the association in a second predetermined range; and
suggesting the method of collecting data comprising jointly collecting the value of the first variable and the value of the second variable.

17. A system comprising:
a retrieving module to retrieve from a database a data set comprising a plurality of variables and a plurality of values corresponding to the plurality of variables;
an association module to determine an association between a pair of variables in the plurality of variables, the association indicating a relationship between a value of a first variable in the pair of variables and a value of a second variable in the pair of variables;
a conversion module to convert the data set into a canonical data model having a plurality of nodes and a plurality of connections between the plurality of nodes, the plurality of connections dependent on the association between the pair of variables being above a first predetermined threshold; and
an action module to perform an action on the canonical data model more efficiently than performing the action on the data set by avoiding an analysis of the pair of variables having the association below a second predetermined threshold.

18. The system of claim 17, the system comprising:
a categorization module to categorize the plurality of variables into a plurality of canonical data types comprising a continuous variable and a categorical variable, wherein the continuous variable comprises a variable having a number of values above the first predetermined threshold, and wherein the categorical variable comprises a variable having a number of values below the second predetermined threshold.

19. The system of claim 18, the categorization module to:
clean the canonical data model of spurious data by detecting a significant variation in the variable categorized as the continuous variable; and
smooth the significant variation based on a value of the variable proximate to the significant variation.

20. The system of claim 17, the conversion module to:
create a first node in the canonical data model representing a continuous variable; and
create a second node in the canonical data model representing a value of a categorical variable.

21. The system of claim 20, the conversion module to:
create a third node in the canonical data model representing at least one of a mean or a variance of the continuous variable; and
establish a connection between the third node and the first node.

22. The system of claim 17, the action module comprising a cleaning module to clean the canonical data model of spurious data, the cleaning module to:
detecting a variable in the pair of variables having an inconsistently present value;
based on a present value of the variable determining a mode value; and
replacing the inconsistently present value with the mode value.

23. The system of claim 17, the action module comprising a merging module to merge a plurality of disparate data sets, the merging module to:
obtain a second canonical data model corresponding to a second data set;
determine corresponding variables between the data set and the second data set based on the structure of the canonical data model and a second structure of the second canonical data model; and
merge the corresponding variables in the data set and the second data set into a merged data set.

24. The system of claim 23, the merging module to:
determine the corresponding variables based on similarity of values associated with a variable in the data set and a second variable in the second data set, or similarity of connectivities between a node in the canonical data model corresponding to the variable and a node in the second canonical data model corresponding to the second variable.

25. The system of claim 17, the action module comprising an analysis module to analyze the data set, the analysis module to:
detect a subset of nodes in the plurality of nodes in the canonical data model having a significant association; and
indicate a causal relationship between the subset of nodes.

26. The system of claim 17, the action module comprising a compression module to compress the data set, the compression module to:
reduce a memory footprint of the data set by replacing the data set with the canonical data model.

27. The system of claim 17, the action module comprising a compression module to compress the data set, the compression module to:
detect a node in the canonical data model having an insignificant association with substantially all the rest of the plurality of nodes in the canonical data model; and
compress a value of a variable associated with the node using lossy compression.

28. The system of claim 17, the action module comprising a compression module to compress the data set, the compression module to:
detect a node in the canonical data model having a significant association with a second node in the canonical data model; and
compressing the value of a variable associated with the node by representing the value of the node as a function of a second value associated with the second node.

29. The system of claim 17, the action module comprising a translation module to efficiently convert between two data sets, the translation module to:
obtain the canonical data model and a second data set having a format comprising at least one of a relational database, a flat database, or a risk database; and
converting the canonical data model into the format of the second data set.

30. The system of claim 17, the action module comprising an analysis module to suggest a method of collecting data, the action module to:
determine at least one pair of variables having the association in a second predetermined range; and
suggest the method of collecting data comprising jointly collecting the value of the first variable and the value of the second variable.
